(19) United States
(12) Patent Application Publication
(10) Pub. No.: US 2025/0341846 A1
(43) Pub. Date: Nov. 6, 2025

(54) SYSTEM INFRASTRUCTURE FOR MANNED VERTICAL TAKE-OFF AND LANDING AERIAL VEHICLES

(71) Applicant: ALAUDA AERONAUTICS PTY LTD, Beverley (AU)

(72) Inventors: Matthew James PEARSON, Beverley (AU); Florian BREUT, Beverley (AU)

(73) Assignee: ALAUDA AERONAUTICS PTY LTD, Beverley (AU)

(21) Appl. No.: 18/556,023

(22) PCT Filed: Apr. 20, 2022
(86) PCT No.: PCT/AU2022/050359

§ 371 Date: Jan. 19, 2024

(30) Foreign Application Priority Data
Apr. 20, 2021 (AU) 2021901172

(51) Int. Cl. G05D 1/81; B64C 29/00; G05D 1/622; G05D 109/22; G06T 7/20; G06T 7/70

(52) U.S. Cl. CPC G05D 1/81; B64C 29/0025; G05D 1/622; G06T 7/20; G06T 7/70; G05D 2109/23; G06T 2207/10032

(57) ABSTRACT

Some embodiments relate to a system for communicating with vertical take-off and landing (VTOL) aerial vehicles. An example system comprises: a central server system comprising: a central server system wireless communication system; at least one central server system processor; and central server system memory. The central server system memory stores program instructions accessible by the at least one central server system processor, and is configured to cause the at least one central server system processor to wirelessly transmit wireless information to one or more VTOL aerial vehicles using the central server system wireless communication system. The wireless information comprises an object state estimate and an object state estimate confidence metric. The object state estimate is indicative of a state of an object that is within a region; and the object state estimate confidence metric is indicative of an error associated with the object state estimate.

### TECHNICAL FIELD

Embodiments of this disclosure generally relate to aerial vehicle systems. In particular, embodiments of this disclosure relate to aerial vehicle systems and system infrastructure. In some embodiments, such systems can be used for controlling aerial vehicles to avoid objects.

### BACKGROUND

Aerial vehicles, such as manned vertical take-off and landing (VTOL) aerial vehicles can be controllably propelled within three-dimensional space. In some cases, a manned VTOL aerial vehicle can, for example, be controllably propelled within three-dimensional space that is physically restricted (e.g. indoors) or between walls or other objects. Alternatively, the manned VTOL aerial vehicle can be controllably propelled within artificially restricted three-dimensional space, for example, at heights dictated by an air-traffic controller, or other artificial restriction.

Manned VTOL aerial vehicles may also collide with objects such as birds, walls, buildings or other aerial vehicles during flight. Collision with an object can cause damage to the aerial vehicle, particularly when the aerial vehicle is traveling at a high speed. Furthermore, collisions can be dangerous to people or objects nearby that can be hit by debris or the aerial vehicle itself. This can be a particularly large issue when high density airspace is considered.

A relatively large amount of aerial vehicles may occupy similar airspace and may travel along transverse flightpaths, increasing risks associated with collisions. Furthermore, manned aerial vehicles may also collide with objects because of other factors such as poor visibility, pilot error or slow pilot reaction time.

Infrastructure that is installed in or near the three-dimensional space within which the manned VTOL aerial vehicle is to fly can be used to assist with navigation of the manned VTOL aerial vehicle during flight.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

In some embodiments, there is provided a system. The system may comprise: a central server system comprising: a central server system wireless communication system; at least one central server system processor; and central server system memory; and a manned VTOL aerial vehicle comprising: a body comprising a cockpit; a propulsion system carried by the body to propel the body during flight; a communication system; and a control system; wherein: the central server system memory stores program instructions accessible by the at least one central server system processor. The program instructions are configured to cause the at least one central server system processor to wirelessly transmit wireless information using the central server system wireless communication system. The manned VTOL aerial vehicle may be configured to receive the wireless information using the communication system; the wireless information comprising an object state estimate and an object state estimate confidence metric, wherein; the object state estimate is indicative of a state of an object that is within a region; and the object state estimate confidence metric is indicative of an error associated with the object state estimate. The control system may be configured to control the propulsion system such that the manned VTOL aerial vehicle avoids the object whilst remaining within the region, based at least in part on the object state estimate and the object state estimate confidence metric.

In some embodiments, the control system is configured to enable control of the manned VTOL aerial vehicle to be shared between a pilot and an autonomous piloting system.

In some embodiments, the manned VTOL aerial vehicle is configured to transmit vehicle data using the communication system, and the at least one central server system processor is configured to receive the vehicle data using the central server system wireless communication system.

In some embodiments, the object state estimate comprises one or more of: an object position estimate that is indicative of a position of the object within the region; an object speed vector that is indicative of a velocity of the object; and an object attitude vector that is indicative of an attitude of the object.

In some embodiments, the wireless information comprises a vehicle state estimate and a vehicle state estimate confidence metric; the vehicle state estimate is indicative of a state of the manned VTOL aerial vehicle within the region; and the vehicle state estimate confidence metric is indicative of an error associated with the vehicle state estimate.

In some embodiments, the vehicle state estimate comprises one or more of: a position estimate indicative of a position of the manned VTOL aerial vehicle within the region; a speed vector indicative of a velocity of the manned VTOL aerial vehicle; and an attitude vector that is indicative of an attitude of the manned VTOL aerial vehicle.

In some embodiments, the control system is configured to control the propulsion system such that the manned VTOL aerial vehicle avoids the object whilst remaining within the region, based at least in part on the object state estimate, the object state estimate confidence metric, the vehicle state estimate and the vehicle state estimate confidence metric.

In some embodiments, the system further comprises an external sensing system configured to generate external sensing system data, wherein the external sensing system is configured to provide the external sensing system data to the central server system.

In some embodiments, the external sensing system comprises an external sensing system imaging system that is configured to generate external sensing system image data, wherein the external sensing system data comprises the external sensing system image data.

In some embodiments, the external sensing system imaging system comprises one or more of: an external LIDAR module configured to generate external LIDAR data associated with the region; an external visible spectrum camera configured to generate external sensing system visible spectrum data associated with the region; and an external RADAR module configured to generate external RADAR data associated with the region.

In some embodiments, the external sensing system image data comprises one or more of the external LIDAR data, the external sensing system visible spectrum data and the external RADAR data.

In some embodiments, the system further comprises a repeater.

In some embodiments, the repeater is configured to receive the wireless information transmitted by the central server system and re transmit the wireless information, thereby enabling the central server system to provide the wireless information to the manned VTOL aerial vehicle from an extended distance.

In some embodiments, the repeater is configured to receive vehicle data transmitted by the manned VTOL aerial vehicle, and re-transmit the vehicle data, thereby enabling the manned VTOL aerial vehicle to provide the vehicle data to the central server system from an extended distance.

In some embodiments, the program instructions are further configured to cause the at least one central server system processor to determine the object state estimate and the object state estimate confidence metric based at least in part on the external sensing system data.

In some embodiments, the program instructions are further configured to cause the at least one central server system processor to determine the vehicle state estimate based at least in part on the external sensing system data.

In some embodiments, the program instructions are further configured to cause the at least one central server system processor to determine the object state estimate and the object state estimate confidence metric by using the external image data as an input of a convolutional neural network.

In some embodiments, the program instructions are further configured to cause the at least one central server system processor to determine the vehicle state estimate and the vehicle state estimate confidence metric by using the image data as an input of a convolutional neural network.

In some embodiments, the external sensing system comprises a sensor comprising: a sensor module configured to generate sensor data; at least one sensor processor; and sensor memory storing sensor program instructions accessible by the at least one sensor processor, and configured to cause the at least one sensor processor to determine the object state estimate and the object state estimate confidence metric, based at least in part on the external sensing system data.

In some embodiments, the sensor program instructions are further configured to cause the at least one sensor processor to provide the object state estimate and the object state estimate confidence metric to the central server system.

In some embodiments, the external sensing system comprises a sensor comprising: a sensor module configured to generate sensor data; at least one sensor processor; and sensor memory storing sensor program instructions accessible by the at least one sensor processor.

In some embodiments, the sensor program instructions are configured to cause the at least one sensor processor to determine the vehicle state estimate and the vehicle state estimate confidence metric, based at least in part on the external sensing system data.

In some embodiments, the sensor program instructions are further configured to cause the at least one sensor processor to provide the vehicle state estimate and the vehicle state estimate confidence metric to the central server system.

In some embodiments, the object state estimate comprises an object classification that is indicative of a class of the object.

In some embodiments, the central server system memory is configured to store a three-dimensional model that represents the region.

In some embodiments, the program instructions are further configured to cause the at least one central server system processor to modify the three-dimensional model, based at least in part on the object state estimate and the object state estimate confidence metric, thereby determining a modified three dimensional model; and the wireless information comprises the modified three dimensional model.

In some embodiments, the sensor memory is configured to store a pre-defined three dimensional model that represents the region.

In some embodiments, the sensor program instructions are further configured to cause the at least one sensor processor to modify the pre-defined three dimensional model, based at least in part on the object state estimate and the object state estimate confidence metric, thereby determining a modified three dimensional model.

In some embodiments, the wireless information comprises the modified three dimensional model.

In some embodiments, the program instructions are further configured to cause the at least one central server system processor to determine an alert, based at least in part on the object state estimate, wherein the wireless information comprises the alert.

In some embodiments, the sensor program instructions are further configured to cause the at least one sensor processor to determine an alert, based at least in part on the object state estimate.

In some embodiments, the wireless information comprises the alert.

In some embodiments, there is provided a system. The system may comprise: a sensor configured to generate sensor data, the sensor comprising: a sensor module configured to generate the sensor data; a sensor wireless communication module; at least one sensor processor; and sensor memory that is configured to store the sensor data; and a manned VTOL aerial vehicle comprising: a body comprising a cockpit; a propulsion system carried by the body to propel the body during flight; a vehicle wireless communication system; and a control system; wherein: the sensor memory stores sensor program instructions accessible by the at least one sensor processor. The sensor program instructions are configured to cause the at least one sensor processor to: determine an object state estimate and an object state estimate confidence metric, based at least in part on the sensor data, wherein: the object state estimate is indicative of a state of an object that is within a region; and the object state estimate confidence metric is indicative of an error associated with the object state estimate; and wirelessly transmit wireless information using the sensor wireless communication module, the wireless information comprising the object state estimate and the object state estimate confidence metric. The manned VTOL aerial vehicle is configured to receive the wireless information using the vehicle wireless communication system; and the control system is configured to control the propulsion system such that the manned VTOL aerial vehicle avoids the object whilst remaining within the region, based at least in part on the object state estimate and the object state estimate confidence metric.

In some embodiments, the control system is configured to enable control of the manned VTOL aerial vehicle to be shared between a pilot and an autonomous piloting system.

In some embodiments, the manned VTOL aerial vehicle is configured to transmit vehicle data using the vehicle wireless communication system.

In some embodiments, the at least one sensor processor is configured to receive the vehicle data using the sensor wireless communication module.

In some embodiments, the object state estimate comprises one or more of: an object position estimate that is indicative of a position of the object within the region; an object speed vector that is indicative of a velocity of the object; and an object attitude vector that is indicative of an attitude of the object.

In some embodiments, the sensor program instructions are further configured to cause the at least one sensor processor to: determine a vehicle state estimate and a vehicle state estimate confidence metric, wherein: the vehicle state estimate is indicative of a state of the manned VTOL aerial vehicle within the region; and the vehicle state estimate confidence metric is indicative of an error associated with the vehicle state estimate; and wherein the wireless information comprises the vehicle state estimate and the vehicle state estimate confidence metric.

In some embodiments, the control system is configured to control the propulsion system such that the manned VTOL aerial vehicle avoids the object whilst remaining within the region, based at least in part on the object state estimate, the object state estimate confidence metric, the vehicle state estimate and the vehicle state estimate confidence metric.

In some embodiments, the vehicle state estimate comprises one or more of: a position estimate indicative of a position of the manned VTOL aerial vehicle within the region; a speed vector indicative of a velocity of the manned VTOL aerial vehicle; and an attitude vector that is indicative of an attitude of the manned VTOL aerial vehicle.

In some embodiments, the sensor module is configured to generate external sensing system image data, wherein the sensor data comprises the external sensing system image data.

In some embodiments, the sensor module comprises one or more of: an external LIDAR module configured to generate external LIDAR data associated with the region; an external visible spectrum camera configured to generate external sensing system visible spectrum data associated with the region; and an external RADAR module configured to generate external RADAR data associated with the region.

In some embodiments, the external sensing system image data comprises one or more of the external LIDAR data, the external sensing system visible spectrum data and the external RADAR data.

In some embodiments, the system further comprises a repeater.

In some embodiments, the repeater is configured to receive the wireless information transmitted by the sensor and re-transmit the wireless information, thereby enabling the sensor to provide the wireless information to the manned VTOL aerial vehicle from an extended distance.

In some embodiments, the repeater is configured to receive the vehicle data transmitted by the manned VTOL aerial vehicle, and re-transmit the vehicle data, thereby enabling the manned VTOL aerial vehicle to provide the vehicle data to the sensor from an extended distance.

In some embodiments, determining the object state estimate and the object state estimate confidence metric comprises using the sensor data as an input of a convolutional neural network.

In some embodiments, determining the vehicle state estimate and the vehicle state estimate confidence metric comprises using the sensor data as an input of a convolutional neural network.

In some embodiments, the object state estimate comprises an object classification that is indicative of a class of the object.

In some embodiments, the sensor memory is configured to store a pre-defined three-dimensional region that represents the region.

In some embodiments, the sensor program instructions are further configured to cause the at least one sensor processor to modify the pre-defined three dimensional model, based at least in part on the object state estimate and the object state estimate confidence metric, thereby determining a modified there-dimensional model.

In some embodiments, the wireless information comprises the modified three-dimensional model.

In some embodiments, the sensor program instructions are further configured to cause the at least one sensor processor to determine an alert, based at least in part on the object state estimate.

In some embodiments, the wireless information comprises the alert.

In some embodiments, the system further comprises a plurality of sensors, wherein: the plurality of sensors comprises the sensor; and the sensors of the plurality of sensors are distributed throughout the region.

In some embodiments, each sensor of the plurality of sensors comprises a respective sensor wireless communication module.

In some embodiments, each sensor of the plurality of sensor is configured to communicate with another sensor of the plurality of sensors using the respective sensor wireless communication module.

In some embodiments, the system further comprises a central server system, wherein the sensor module is configured to communicate with the central server system using the sensor wireless communication module.

In some embodiments, there is provided a system. The system may comprise: a central server system comprising: a central server system wireless communication system; at least one central server system processor; and central server system memory; and a manned VTOL aerial vehicle comprising: a body comprising a cockpit; a propulsion system carried by the body to propel the body during flight; a communication system; and a control system; wherein: the central server system memory stores program instructions accessible by the at least one central server system processor, and configured to cause the at least one central server system processor to wirelessly transmit wireless information using the central server system wireless communication system; the manned VTOL aerial vehicle is configured to receive the wireless information using the communication system; and the control system is configured to control the propulsion system based at least in part on the wireless information.

In some embodiments, there is provided a system. The system may comprise: a central server system comprising: a central server system wireless communication system; at least one central server system processor; and central server system memory; wherein: the central server system memory stores program instructions accessible by the at least one central server system processor. The program instructions are configured to cause the at least one central server system processor to wirelessly transmit wireless information to one or more VTOL aerial vehicles using the central server system wireless communication system; the wireless information comprises an object state estimate and an object state estimate confidence metric, wherein; the object state estimate is indicative of a state of an object that is within a region; and the object state estimate confidence metric is indicative of an error associated with the object state estimate.

In some embodiments, the at least one central server system processor is configured to receive vehicle data from one or more VTOL aerial vehicles using the central server system wireless communication system.

In some embodiments, the object state estimate comprises one or more of: an object position estimate that is indicative of a position of the object within the region; an object speed vector that is indicative of a velocity of the object; and an object attitude vector that is indicative of an attitude of the object.

In some embodiments, the wireless information comprises a vehicle state estimate and a vehicle state estimate confidence metric; the vehicle state estimate is indicative of a state of a VTOL aerial vehicle within the region; and the vehicle state estimate confidence metric is indicative of an error associated with the vehicle state estimate.

In some embodiments, the vehicle state estimate comprises one or more of: a position estimate indicative of a position of the manned VTOL aerial vehicle within the region; a speed vector indicative of a velocity of the manned VTOL aerial vehicle; and an attitude vector that is indicative of an attitude of the manned VTOL aerial vehicle.

In some embodiments, the system further comprises an external sensing system configured to generate external sensing system data, wherein the external sensing system is configured to provide the external sensing system data to the central server system.

In some embodiments, the external sensing system comprises an external sensing system imaging system that is configured to generate external sensing system image data, wherein the external sensing system data comprises the external sensing system image data.

In some embodiments, the external sensing system imaging system comprises one or more of: an external LIDAR module configured to generate external LIDAR data associated with the region; an external visible spectrum camera configured to generate external sensing system visible spectrum data associated with the region; and an external RADAR module configured to generate external RADAR data associated with the region; and wherein the external sensing system image data comprises one or more of the external LIDAR data, the external sensing system visible spectrum data and the external RADAR data.

In some embodiments, the system further comprises a repeater.

In some embodiments, the repeater is configured to receive the wireless information transmitted by the central server system and re-transmit the wireless information, thereby enabling the central server system to provide the wireless information from an extended distance.

In some embodiments, the repeater is configured to receive vehicle data, and re-transmit the vehicle data, thereby enabling the central server system to receive the vehicle data from an extended distance.

In some embodiments, the program instructions are further configured to cause the at least one central server system processor to determine the object state estimate and the object state estimate confidence metric based at least in part on the external sensing system data.

In some embodiments, the program instructions are further configured to cause the at least one central server system processor to determine the vehicle state estimate based at least in part on the external sensing system data.

In some embodiments, the program instructions are further configured to cause the at least one central server system processor to determine the object state estimate and the object state estimate confidence metric by using the external image data as an input of a convolutional neural network.

In some embodiments, the program instructions are further configured to cause the at least one central server system processor to determine the vehicle state estimate and the vehicle state estimate confidence metric by using the image data as an input of a convolutional neural network.

In some embodiments, the external sensing system comprises a sensor comprising: a sensor module configured to generate sensor data; at least one sensor processor; and sensor memory storing sensor program instructions accessible by the at least one sensor processor, and configured to cause the at least one sensor processor to determine the object state estimate and the object state estimate confidence metric, based at least in part on the external sensing system data.

In some embodiments, the sensor program instructions are further configured to cause the at least one sensor processor to provide the object state estimate and the object state estimate confidence metric to the central server system.

In some embodiments, the external sensing system comprises a sensor comprising: a sensor module configured to generate sensor data; at least one sensor processor; and sensor memory storing sensor program instructions accessible by the at least one sensor processor, and configured to cause the at least one sensor processor to determine the vehicle state estimate and the vehicle state estimate confidence metric, based at least in part on the external sensing system data.

In some embodiments, the sensor program instructions are further configured to cause the at least one sensor processor to provide the vehicle state estimate and the vehicle state estimate confidence metric to the central server system.

In some embodiments, the object state estimate comprises an object classification that is indicative of a class of the object.

In some embodiments, the central server system memory is configured to store a three-dimensional model that represents the region.

In some embodiments, the program instructions are further configured to cause the at least one central server system processor to modify the three-dimensional model, based at least in part on the object state estimate and the object state estimate confidence metric, thereby determining a modified three-dimensional model; and the wireless information comprises the modified three-dimensional model.

In some embodiments, the sensor memory is configured to store a pre-defined three-dimensional model that represents the region.

In some embodiments, the sensor program instructions are further configured to cause the at least one sensor processor to modify the pre-defined three-dimensional model, based at least in part on the object state estimate and the object state estimate confidence metric, thereby determining a modified three-dimensional model; and the wireless information comprises the modified three-dimensional model.

In some embodiments, the program instructions are further configured to cause the at least one central server system processor to determine an alert, based at least in part on the object state estimate, wherein the wireless information comprises the alert.

In some embodiments, the sensor program instructions are further configured to cause the at least one sensor processor to determine an alert, based at least in part on the object state estimate, wherein the wireless information comprises the alert.

In some embodiments, there is provided a system. The system may comprise: a sensor configured to generate sensor data, the sensor comprising: a sensor module configured to generate the sensor data; a sensor wireless communication module; at least one sensor processor; and sensor memory that is configured to store the sensor data; wherein: the sensor memory stores sensor program instructions accessible by the at least one sensor processor, and configured to cause the at least one sensor processor to: determine an object state estimate and an object state estimate confidence metric, based at least in part on the sensor data, wherein: the object state estimate is indicative of a state of an object that is within a region; and the object state estimate confidence metric is indicative of an error associated with the object state estimate; and wirelessly transmit wireless information to one or more VTOL aerial vehicles using the sensor wireless communication module, the wireless information comprising the object state estimate and the object state estimate confidence metric.

In some embodiments, the at least one sensor processor is configured to receive vehicle data from one or more VTOL aerial vehicles using the sensor wireless communication module.

In some embodiments, the object state estimate comprises one or more of: an object position estimate that is indicative of a position of the object within the region; an object speed vector that is indicative of a velocity of the object; and an object attitude vector that is indicative of an attitude of the object.

In some embodiments, the sensor program instructions are further configured to cause the at least one sensor processor to: determine a vehicle state estimate and a vehicle state estimate confidence metric, wherein: the vehicle state estimate is indicative of a state of a manned VTOL aerial vehicle within the region; and the vehicle state estimate confidence metric is indicative of an error associated with the vehicle state estimate; and wherein the wireless information comprises the vehicle state estimate and the vehicle state estimate confidence metric.

In some embodiments, the vehicle state estimate comprises one or more of: a position estimate indicative of a position of the manned VTOL aerial vehicle within the region; a speed vector indicative of a velocity of the manned VTOL aerial vehicle; and an attitude vector that is indicative of an attitude of the manned VTOL aerial vehicle.

In some embodiments, the sensor module is configured to generate external sensing system image data, wherein the sensor data comprises the external sensing system image data.

In some embodiments, the sensor module comprises one or more of: an external LIDAR module configured to generate external LIDAR data associated with the region; an external visible spectrum camera configured to generate external sensing system visible spectrum data associated with the region; and an external RADAR module configured to generate external RADAR data associated with the region.

In some embodiments, the external sensing system image data comprises one or more of the external LIDAR data, the external sensing system visible spectrum data and the external RADAR data.

In some embodiments, the system further comprises a repeater.

In some embodiments, the repeater is configured to receive the wireless information transmitted by the sensor and re-transmit the wireless information, thereby enabling the sensor to provide the wireless information from an extended distance.

In some embodiments, the repeater is configured to receive vehicle data, and re-transmit the vehicle data, thereby enabling the sensor to receive the vehicle data from an extended distance.

In some embodiments, determining the object state estimate and the object state estimate confidence metric comprises using the sensor data as an input of a convolutional neural network.

In some embodiments, determining the vehicle state estimate and the vehicle state estimate confidence metric comprises using the sensor data as an input of a convolutional neural network.

In some embodiments, the object state estimate comprises an object classification that is indicative of a class of the object.

In some embodiments, the sensor memory is configured to store a pre-defined three-dimensional region that represents the region.

In some embodiments, the sensor program instructions are further configured to cause the at least one sensor processor to modify the pre-defined three-dimensional model, based at least in part on the object state estimate and the object state estimate confidence metric, thereby determining a modified there-dimensional model.

In some embodiments, the wireless information comprises the modified three-dimensional model.

In some embodiments, the sensor program instructions are further configured to cause the at least one sensor processor to determine an alert, based at least in part on the object state estimate.

In some embodiments, the wireless information comprises the alert.

In some embodiments, the system further comprises a plurality of sensors, wherein: the plurality of sensors comprises the sensor; and the sensors of the plurality of sensors are distributed throughout the region.

In some embodiments, each sensor of the plurality of sensors comprises a respective sensor wireless communication module; and each sensor of the plurality of sensors is configured to communicate with another sensor of the plurality of sensors using the respective sensor wireless communication module.

In some embodiments, the system further comprises a central server system, wherein the sensor module is configured to communicate with the central server system using the sensor wireless communication module.

In some embodiments, there is provided a system. The system may comprise: a central server system comprising: a central server system wireless communication system; at least one central server system processor; and central server system memory; and wherein: the central server system memory stores program instructions accessible by the at least one central server system processor, and configured to cause the at least one central server system processor to wirelessly transmit wireless information to one or more VTOL aerial vehicles using the central server system wireless communication system.

### BRIEF DESCRIPTION OF DRAWINGS

Embodiments of the present disclosure will now be described by way of non-limiting example only with reference to the accompanying drawings, in which:

FIG. 1 illustrates a front perspective view of a manned VTOL aerial vehicle, according to some embodiments;

FIG. 2 illustrates a rear perspective view of the manned VTOL aerial vehicle, according to some embodiments;

FIG. 3 is a block diagram of an aerial vehicle system, according to some embodiments;

FIG. 4 is a block diagram of the aerial vehicle system of FIG. 3, when in the context of a manned VTOL aerial vehicle race track;

FIG. 5 is a block diagram of a control system of the manned VTOL aerial vehicle, according to some embodiments;

FIG. 6 is a block diagram of an alternative control system of the manned VTOL aerial vehicle, according to some embodiments;

FIG. 7 is a block diagram of a sensing system of the manned VTOL aerial vehicle, according to some embodiments;

FIG. 8 illustrates a front perspective view of a manned VTOL aerial vehicle, showing example positions of a plurality of sensors of a sensor module, according to some embodiments;

FIG. 9 is a block diagram of an external sensing system, according to some embodiments;

FIG. 10 is a block diagram of an aerial vehicle system, according to some embodiments;

FIG. 11 is a block diagram of the aerial vehicle system of FIG. 10, when in the context of a manned VTOL aerial vehicle race track; and

FIG. 12 is a block diagram of a propulsion system, according to some embodiments.

### DESCRIPTION OF EMBODIMENTS

Manned vertical take-off and landing (VTOL) aerial vehicles are used in a number of applications. For example, competitive manned VTOL aerial vehicle racing can involve a plurality of manned VTOL aerial vehicles navigating a track, each with a goal of navigating the track in the shortest amount of time. The track may have a complex shape, may cover a large area and/or may include a number of obstacles around which the manned VTOL aerial vehicles must navigate (including other vehicles), for example.

It is important to minimise the likelihood of manned VTOL aerial vehicles colliding, either with other vehicles or objects. For example, in the context of racing, it is important that the manned VTOL aerial vehicles do not collide with other vehicles in the race or objects associated with the track (e.g. the ground, walls, trees, unmanned autonomous aerial vehicles, birds etc.). Furthermore, the track may include virtual objects that are visible, for example, through a heads-up display (HUD) and avoiding these virtual objects is also important. Collision with an object can cause damage to the manned VTOL aerial vehicle, particularly when the manned VTOL aerial vehicle is traveling at a high speed. Furthermore, collisions can be dangerous to people or objects nearby that can be hit by debris or the manned VTOL aerial vehicle itself.

A significant technical problem exists in providing a manned VTOL aerial vehicle that a pilot can navigate across a region (e.g. the track) whilst minimising the risk that the manned VTOL aerial vehicle crashes (e.g. due to pilot error, equipment failure etc.).

Determining an accurate estimate of the manned VTOL aerial vehicle's state can assist with vehicle navigation to, for example, reduce the risk that the manned VTOL aerial vehicle collides with an object in the region, or unintentionally leaves the region. Infrastructure that is provided in addition to that of the manned VTOL aerial vehicle can be useful for determining or improving estimates of the manned VTOL aerial vehicle's state, or the state of objects within the track. As track infrastructure is not required to be easily mobile, additional computing hardware (external to the computing hardware of the manned VTOL aerial vehicle) can be provided as part of the track infrastructure. This enables the rapid execution of complex processes, such as determining state estimates of the manned VTOL aerial vehicle, or state estimates of objects within the track without requiring the computing hardware to be carried by the manned VTOL aerial vehicle itself. A low-latency network connection can be maintained between the manned VTOL aerial vehicle and the track infrastructure so that the track infrastructure can provide the results of its calculations (e.g. the state estimates of the manned VTOL aerial vehicle and/or object(s)) to the manned VTOL aerial vehicle.

### Manned Vertical Take-Off and Landing Aerial Vehicle

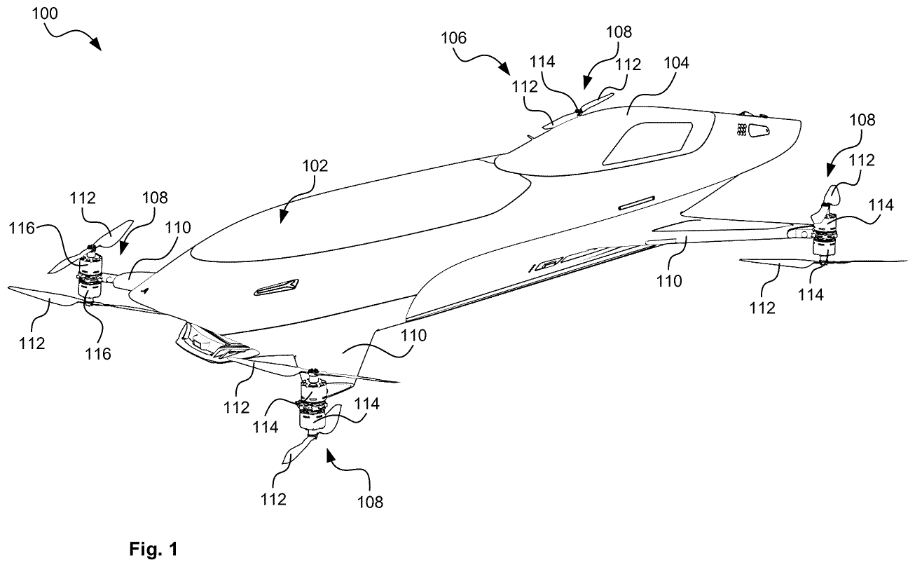

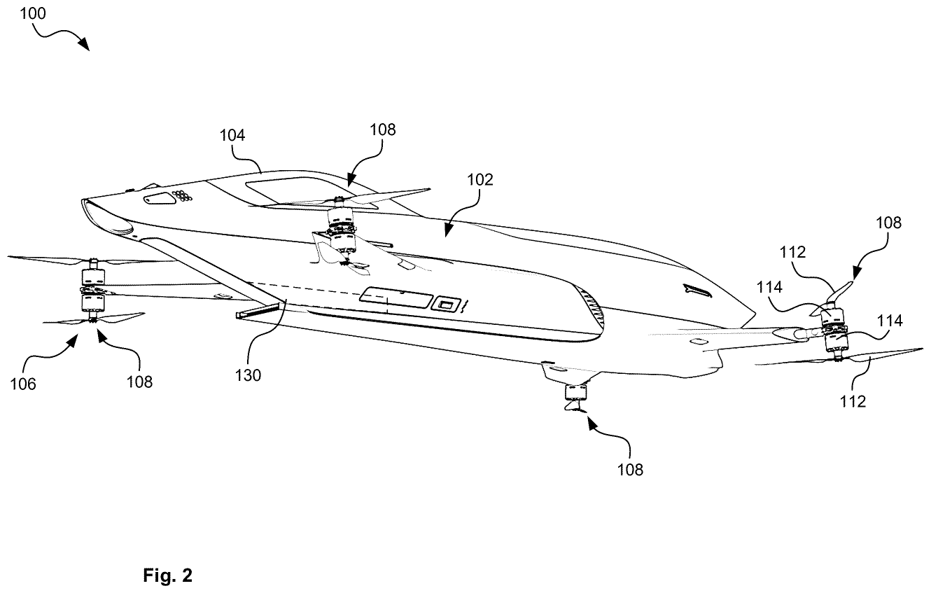

FIG. 1 illustrates a front perspective view of a manned vertical take-off and landing aerial vehicle 100. FIG. 2 illustrates a rear perspective view of the manned VTOL aerial vehicle 100. The manned VTOL aerial vehicle 100 is configured to move within a region. Specifically, the manned VTOL aerial vehicle 100 is configured to fly within a region that comprises an object 113. In some embodiments, the manned VTOL aerial vehicle 100 may be referred to as a speeder.

The manned VTOL aerial vehicle 100 is a rotary wing vehicle. The manned VTOL aerial vehicle 100 can move omnidirectionally in a three-dimensional space. In some embodiments, the manned VTOL aerial vehicle 100 has a constant deceleration limit. In some embodiments, the manned VTOL aerial vehicle 100 is in the form of an electric vertical take-off and landing aerial vehicle (eVTOL). In such embodiments, the VTOL aerial vehicle 100 includes one rechargeable electric battery or multiple rechargeable electric batteries to supply power for operation of the various powered components of the VTOL aerial vehicle 100.

The manned VTOL aerial vehicle 100 comprises a body 102. The body 102 may comprise a fuselage. The body 102 comprises a cockpit 104 sized and configured to accommodate a human pilot. The cockpit 104 comprises a display (not shown). The display is configured to display information to the pilot. The display may be implemented as a heads-up display, an electroluminescent (ELD) display, light-emitting diode (LED) display, quantum dot (QLED) display, organic light-emitting diode (OLED) display, liquid crystal display, a plasma screen, as a cathode ray screen device or the like.

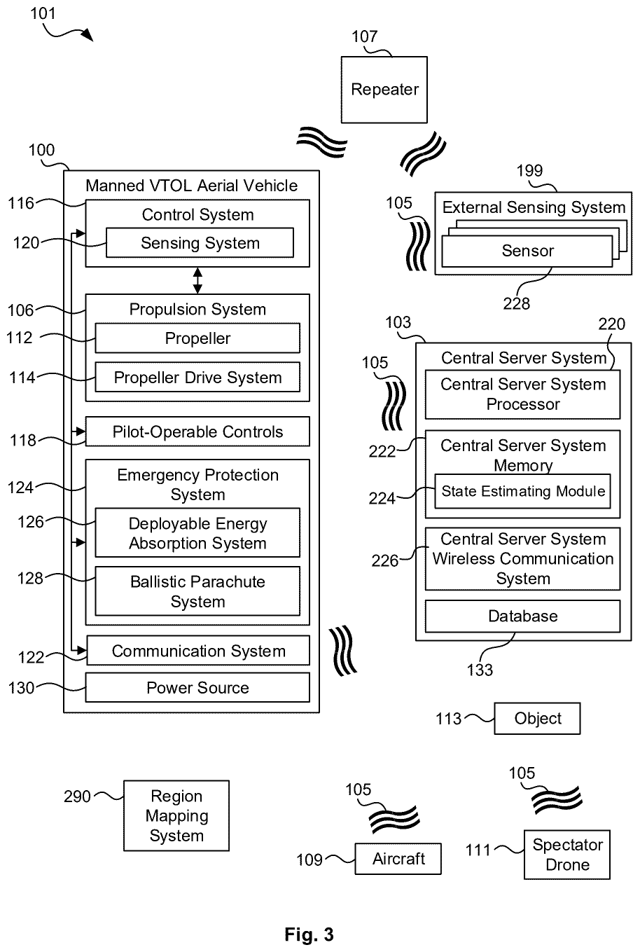

In some embodiments, the body 102 comprises, or is in the form of a monocoque. For example, the body 102 may comprise or be in the form of a carbon fibre monocoque. The manned VTOL aerial vehicle 100 comprises pilot-operable controls 118 (FIG. 3) that are accessible from the cockpit 104. The manned VTOL aerial vehicle 100 comprises a propulsion system 106. The propulsion system 106 is carried by the body 102 to propel the body 102 during flight.

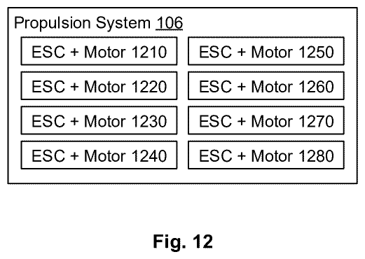

The propulsion system 106 comprises a propeller system 108. The propeller system 108 comprises a plurality of propellers 112 and a plurality of propeller drive systems 114. That is, the propeller system 108 comprises multiple propellers 112 and a propeller drive system 114 for each propeller 112. The propeller drive system 114 comprises a propeller motor. In particular, the propeller drive system 114 may comprise a brushless motor. The propeller motor may be controlled via an electronic speed control (ESC) circuit for each propeller 112 of the propeller system 108, as illustrated in FIG. 12.

FIG. 12 is a block diagram of propulsion system 106 according to some embodiments. Propulsion system 106 may comprise a plurality of electronic speed controller (ESC) and motor pairs 1210, 1220, 1230, 1240, 1250, 1260, 1270, and 1280. The eight ESC and motor pairs are used to control pairs of propellers 112. That is, two ESC and motor pairs are used in conjunction with one another for a total of four propeller systems 108, for example. Propulsion system 106 is carried by the body 102 to propel the body 102 during flight.

The propulsion system 106 of the manned VTOL aerial vehicle 100 illustrated in FIG. 1 and FIG. 2 comprises a plurality of propeller systems 108. In particular, the propulsion system 106 of the manned VTOL aerial vehicle 100 illustrated in FIG. 1 and FIG. 2 comprises four propeller systems 108. Each propeller system 108 comprises a first propeller and a first propeller drive system. Each propeller system 108 also comprises a second propeller and a second propeller drive system. The first propeller drive system is configured to selectively rotate the first propeller in a first direction of rotation or a second direction opposite the first direction. The second propeller drive system is configured to selectively rotate the second propeller in the first direction of rotation or the second direction.

Each propeller system 108 is connected to a respective elongate body portion 110 of the body 102. The elongate body portions 110 may be referred to as “arms” of the body 102. Each propeller system 108 is mounted to the body 102 such that the propeller systems 108 form a generally quadrilateral profile.

By selective control of the propeller systems 108, the manned VTOL aerial vehicle 100 can be accurately controlled to move within three-dimensional space. The manned VTOL aerial vehicle 100 is capable of vertical take-off and landing.

The object 113 may be a static object. That is, the object 113 may be static with respect to the region (or a fixed reference frame of the region). Further, the object 113 may be static with respect to a fixed reference frame of the repulsion potential field model. The object 113 may be a dynamic object. That is, the object 113 may be dynamic (or move) with respect to the region (or the fixed reference frame of the region) over time. Alternatively, the object 113 may be dynamic with respect to a fixed reference frame of the repulsion potential field model.

The object 113 may be a real object. That is, the object 113 may exist within the three-dimensional space of the region. For example, the object 113 may define a surface (such as the ground, a wall, a ceiling etc.) or an obstacle (such as another vehicle, a track marker, a tree or a bird). Alternatively, the object 113 may be a virtual object. For example, the object 113 may be defined only in a repulsive field model, or a three-dimensional model. For example, the object 113 may be a virtual surface (such as a virtual wall, a virtual ceiling etc.), a virtual obstacle (such as a virtual vehicle, a virtual track marker, a virtual tree or a virtual bird) or a virtual boundary within which it is desired to maintain the manned VTOL aerial vehicle 100.

Virtual objects can be useful for artificially constraining the region within which the manned VTOL aerial vehicle can fly. For example, the virtual object can be in the form of a three-dimensional virtual boundary. The manned VTOL aerial vehicle 100 may be authorised to fly within the three-dimensional virtual boundary (e.g. a race track), and unauthorised to fly outside the three-dimensional virtual boundary. The three-dimensional virtual boundary can form a complex three-dimensional flight path, allowing simulation of a technically challenging flight path. Thus, the virtual objects can be used for geofencing. Virtual objects can also be used for pilot training. For example, when the pilot trains to race the manned VTOL aerial vehicle 100, other vehicles against which the pilot can race can be simulated using virtual objects. This reduces the need to actually have other vehicles present, and improves the safety of the pilot, as the risk of the pilot crashing is reduced.

In some embodiments, the region comprises a plurality of objects 113. A first sub-set of the plurality of objects 113 may be dynamic objects. A second sub-set of the plurality of objects may be static objects.

### Aerial Vehicle System

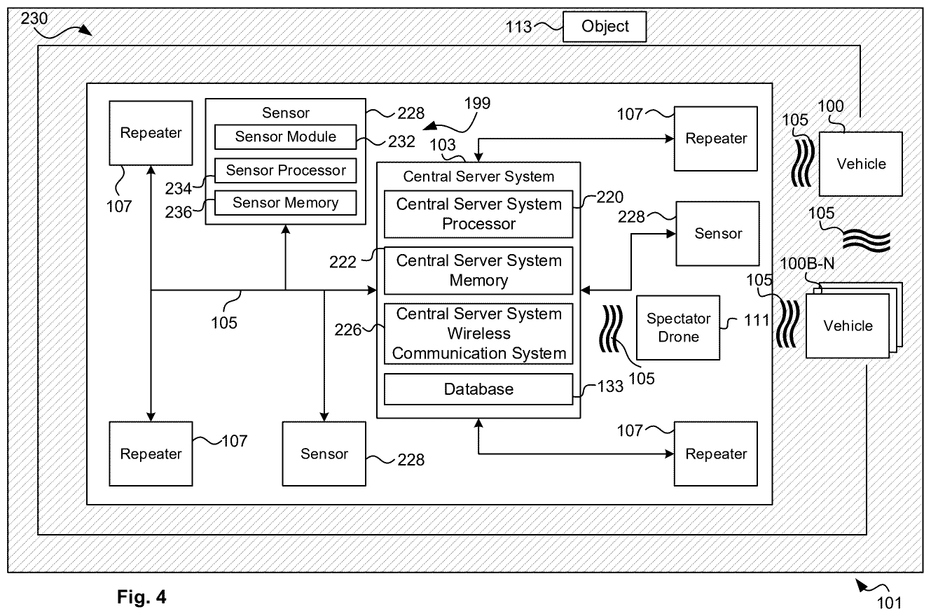

FIGS. 3 and 4 are block diagrams of an aerial vehicle system 101, according to some embodiments. The aerial vehicle system 101 comprises the manned VTOL aerial vehicle 100. As previously described, the manned VTOL aerial vehicle 100 comprises a propulsion system 106 that comprises a plurality of propellers 112 and propeller drive systems 114. The manned VTOL aerial vehicle 100 comprises a control system 116. The control system 116 is configured to enable control of the manned VTOL aerial vehicle 100 to be shared between a pilot and an autonomous piloting system. The control system 116 is configured to communicate with the propulsion system 106. In particular, the control system 116 is configured to control the propulsion system 106 so that the propulsion system 106 can selectively propel the body 102 during flight.

The manned VTOL aerial vehicle 100 comprises a sensing system 120. In particular, the control system 116 comprises the sensing system 120. The sensing system 120 is configured to generate sensor data. The control system 116 is configured to process the sensor data to control the manned VTOL aerial vehicle 100.

The manned VTOL aerial vehicle 100 comprises pilot-operable controls 118. A pilot can use the pilot-operable controls 118 to control the manned VTOL aerial vehicle 100 in flight. The pilot-operable controls are configured to communicate with the control system 116. In particular, the control system 116 processes input data generated by actuation of the pilot-operable controls 118 by the pilot to control the manned VTOL aerial vehicle 100. The control system 116 is configured to process the input data generated by the actuation of the pilot-operable controls 118. In some embodiments, the input data is in the form of an input vector. The input data may be indicative of an intended control velocity of the manned VTOL aerial vehicle 100, as is described in more detail herein.

The manned VTOL aerial vehicle 100 comprises a communication system 122. The communication system 122 may be a wireless communication system. The communication system 122 is configured to communicate with the control system 116. The manned VTOL aerial vehicle 100 is configured to communicate with other computing devices using the communication system 122. The communication system 122 may comprise a vehicle network interface 155. The vehicle network interface 155 is configured to enable the manned VTOL aerial vehicle 100 to communicate with other computing devices using one or more communications networks. The manned VTOL aerial vehicle 100 is configured to communicate with other computing devices using the communication system 122 and a communications network 105, as is described in more detail herein.

The vehicle network interface 155 may comprise a combination of network interface hardware and network interface software suitable for establishing, maintaining and facilitating communication over a relevant communication channel. Examples of a suitable communications network include a cloud server network, a wired or wireless internet connection, a wireless local area network (WLAN) such as Wi-Fi (IEEE 82.15.1) or Zigbee (IEE 802.15.4), a wireless wide area network (WWAN) such as cellular 4G LTE and 5G or another cellular network connection, low power wide area networks (LPWAN) such as SigFox and Lora, Bluetooth™ or other near field radio communication, and/or physical media such as a Universal Serial Bus (USB) connection.

The manned VTOL aerial vehicle 100 also comprises an internal communication network (not shown). The internal communication network is a wired network. The internal communication network connects the at least one processor 132, memory 134 and other components of the manned VTOL aerial vehicle 100 such as the propulsion system 106. The internal communication network may comprise a serial link, Ethernet network, a controlled area network (CAN) or another network.

The manned VTOL aerial vehicle 100 comprises an emergency protection system 124. The emergency protection system 124 is in communication with the control system 116. The emergency protection system 124 is configured to protect the pilot and/or the manned VTOL aerial vehicle 100 in a case where the manned VTOL aerial vehicle 100 is in a collision. That is, the control system 116 may deploy one or more aspects of the emergency protection system 124 to protect the pilot and/or the manned VTOL aerial vehicle 100.

The emergency protection system 124 comprises a deployable energy absorption system 126. In some embodiments, the deployable energy absorption system 126 comprises an airbag. The deployable energy absorption system 126 is configured to deploy in the case where the manned VTOL aerial vehicle 100 is in a collision. The deployable energy absorption system 126 may deploy if an acceleration of the manned VTOL aerial vehicle 100 exceeds an acceleration threshold. For example, the deployable energy absorption system 126 may deploy if the control system 116 senses or determines a deceleration magnitude of the manned VTOL aerial vehicle 100 that is indicative of a magnitude of a deceleration of the manned VTOL aerial vehicle 100 is greater than a predetermined deceleration magnitude threshold.

The emergency protection system 124 comprises a ballistic parachute system 128. The ballistic parachute system 128 is configured to deploy to protect the pilot and/or the manned VTOL aerial vehicle 100 in a number of conditions. These may include the case where the manned VTOL aerial vehicle 100 is in a collision, or where the propulsion system 106 malfunctions. For example, if one or more of the propeller drive systems 114 fail and the manned VTOL aerial vehicle 100 is unable to be landed safely, the ballistic parachute system 128 may deploy to slow the descent of the manned VTOL aerial vehicle 100. In some cases, the ballistic parachute system 128 is configured to deploy if two propeller drive systems 114 on one elongate body portion 110 fail.

The manned VTOL aerial vehicle 100 comprises a power source 130. The power source 130 may comprise one or more batteries. For example, the manned VTOL aerial vehicle 100 may comprise one or more batteries that are stored in a lower portion of the body 102. For example, as shown in FIG. 2, the batteries may be stored below the cockpit 104. The power source 130 is configured to power each sub-system of the manned VTOL aerial vehicle 100 (e.g. the control system 116, propulsion system 106 etc.). The manned VTOL aerial vehicle 100 comprises a battery management system. The battery management system is configured to estimate a charge state of the one or more batteries. The battery management system is configured to perform battery balancing. The battery management system is configured to monitor the health of the one or more batteries. The battery management system is configured to monitor a temperature of the one or more batteries. The battery management system is configured to monitor a tension of the one or more batteries. The battery management system is configured to isolate a battery of the one or more batteries from a load, if required. The battery management system is configured to saturate an input power of the one or more batteries. The battery management system is configured to saturate an output power of the one or more batteries.

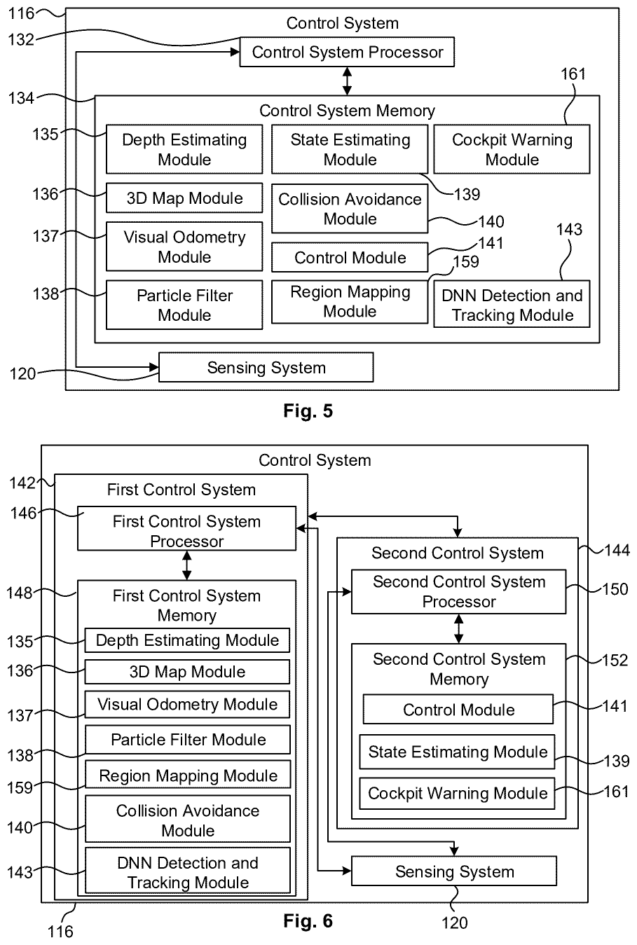

FIG. 5 is a block diagram of the control system 116, according to some embodiments. The control system 116 comprises at least one processor 132. The at least one processor 132 is configured to be in communication with memory 134. As previously described, the control system 116 comprises the sensing system 120. The sensing system 120 is configured to communicate with the at least one processor 132. In some embodiments, the sensing system 120 is configured to provide the sensor data to the at least one processor 132. In some embodiments, the at least one processor 132 is configured to receive the sensor data from the sensing system 120. In some embodiments, the at least one processor 132 is configured to retrieve the sensor data from the sensing system 120. The at least one processor 132 is configured to store the sensor data in the memory 134.

The at least one processor 132 is configured to execute program instructions stored in memory 134 to cause the control system 116 to function as described herein. In particular, the at least one processor 132 is configured to execute the program instructions to cause the manned VTOL aerial vehicle 100 to function as described herein. In other words, the program instructions are accessible by the at least one processor 132, and are configured to cause the at least one processor 132 to function as described herein. In some embodiments, the program instructions may be referred to as control system program instructions.

In some embodiments, the program instructions are in the form of program code. The at least one processor 132 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The program instructions comprise a depth estimating module 135, a three-dimensional map module 136, a visual odometry module 137, a particle filter module 138, a region mapping module 159, a state estimating module 139, a collision avoidance module 140, a cockpit warning module 161, a DNN detection and tracking module 143, and a control module 141.

Memory 134 may comprise one or more volatile or non-volatile memory types. For example, memory 134 may comprise one or more of random access memory (RAM), read-only memory (ROM), electrically erasable programmable read-only memory (EEPROM) or flash memory. Memory 134 is configured to store program code accessible by the at least one processor 132. The program code may comprise executable program code modules. In other words, memory 134 is configured to store executable code modules configured to be executable by the at least one processor 132. The executable code modules, when executed by the at least one processor 132 cause the at least one processor 132 to perform certain functionality, as described herein. In the illustrated embodiment, the depth estimating module 135, the three-dimensional map module 136, the visual odometry module 137, the particle filter module 138, region mapping module 159, the a cockpit warning module 161, the state estimating module 139, the collision avoidance module 140, the DNN detection and tracking module 143, and the control module 141 are in the form of program code stored in the memory 134.

The depth estimating module 135, the three-dimensional map module 136, the visual odometry module 137, the particle filter module 138, the state estimating module 139, the region mapping module 159, the cockpit warning module 161, the collision avoidance module 140, the DNN detection and tracking module 143, and/or the control module 141 are to be understood to be one or more software programs. They may, for example, be represented by one or more functions in a programming language, such as C++, C, Python or Java. The resulting source code may compiled and stored as computer executable instructions on memory 134 that are in the form of the relevant executable code module.

Memory 134 is also configured to store a three-dimensional model. The three-dimensional model may be a three-dimensional model of the region (the track, or a sub-section of the track). That is, the three-dimensional model may represent the region. The three-dimensional model may have an orientation that corresponds with that of the region, and surface of the three-dimensional model may correspond to surfaces of the region. The three-dimensional model may be the three-dimensional model of the region generated by a region mapping system 290, as is described in more detail herein. Positions and/or directions within the three-dimensional model are indicated with respect to a three-dimensional model coordinate system.

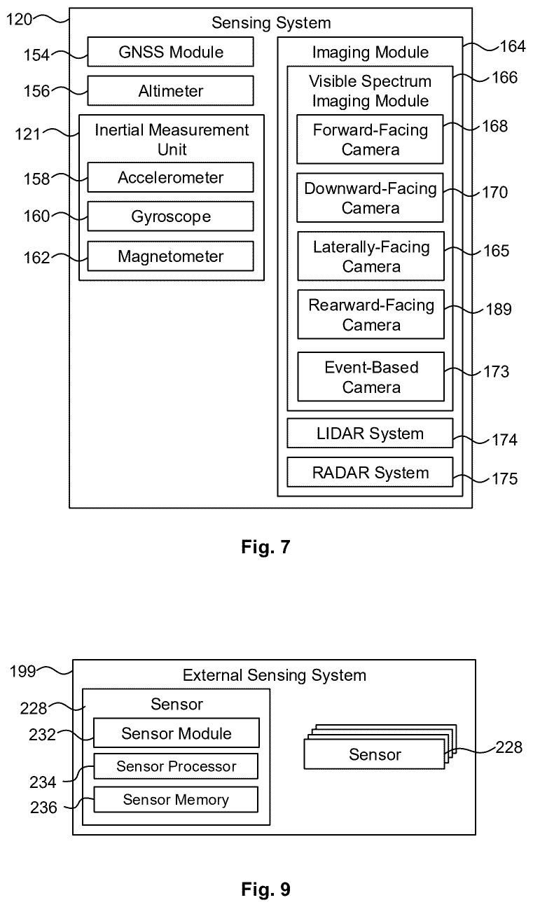

FIG. 7 is a block diagram of the sensing system 120, according to some embodiments. The sensing system 120 comprises a Global Navigation Satellite System (GNSS) module 154. The GNSS module 154 may comprise or be in the form of a GNSS real time kinetics (RTK) sensor. The GNSS module 154 may be configured to receive a Differential GNSS RTK correction signal from a fixed reference ground station. The reference ground station may be a GNSS reference ground station. This may be, for example, via the communications network 105, or another communications network.

The GNSS module 154 is configured to generate GNSS data. The GNSS data is indicative of one or more of a latitude, a longitude and an altitude of the manned VTOL aerial vehicle 100. The GNSS data may be in the form of a GNSS data vector that is indicative of the latitude, longitude and/or altitude of the manned VTOL aerial vehicle 100 at a particular point in time. Alternatively, the GNSS data may comprise GNSS time-series data. The GNSS time-series data can be indicative of the latitude, longitude and/or altitude of the manned VTOL aerial vehicle 100 over a time window. The GNSS time-series data can include GNSS data vectors that are sampled at a particular GNSS time frequency. The GNSS data may include a GNSS uncertainty metric that is indicative of an uncertainty of the relevant GNSS data.

The GNSS module 154 may be configured to utilise a plurality of GNSS constellations. For example, the GNSS module may be configured to utilise one or more of a Global Positioning System (GPS), a Global Navigation Satellite System (GLONASS), a BeiDou Navigation Satellite System (BDS), a Galileo system, a Quasi-Zenith Satellite System (QZSS) and an Indian Regional Navigation Satellite System (IRNSS or NavIC). In some embodiments, the GNSS module 154 is configured to utilise a plurality of GNSS frequencies simultaneously. In some embodiments, the GNSS module 154 is configured to utilise a plurality of GNSS constellations simultaneously.

The GNSS module 154 is configured to provide the GNSS data to the control system 116. In some embodiments, the GNSS module 154 is configured to provide the GNSS data to the at least one processor 132. The GNSS module 154 is configured to provide the GNSS data to the at least one processor 132. The sensor data comprises the GNSS data.

The sensing system 120 comprises an altimeter 156. The altimeter 156 is configured to generate altitude data. The altitude data is indicative of an altitude of the manned VTOL aerial vehicle 100. The altimeter 156 may comprise a barometer. The barometer may be configured to determine an altitude estimate above a reference altitude. The reference altitude may be an altitude threshold. The altimeter 156 may comprise a radar altimeter 163. The radar altimeter 163 is configured to determine an estimate of an above-ground altitude. That is, the radar altimeter 163 is configured to determine an estimate of a distance between the manned VTOL aerial vehicle 100 and the ground. The altimeter 156 is configured to provide the altitude data to the control system 116. In some embodiments, the altimeter 156 is configured to provide the altitude data to the at least one processor 132. The sensor data comprises the altitude data.

The sensing system 120 comprises an inertial measurement unit 121. The inertial measurement unit 121 comprises an accelerometer 158. The accelerometer 158 is configured to generate accelerometer data. The accelerometer data is indicative of an acceleration of the manned VTOL aerial vehicle 100. The accelerometer data is indicative of acceleration in one or more of a first acceleration direction, a second acceleration direction and a third acceleration direction. The first acceleration direction, second acceleration direction and third acceleration direction may be orthogonal with respect to each other. The accelerometer 158 is configured to provide the accelerometer data to the control system 116. In some embodiments, the accelerometer 158 is configured to provide the accelerometer data to the at least one processor 132. The sensor data comprises the accelerometer data.

The inertial measurement unit 121 comprises a gyroscope 160. The gyroscope 160 is configured to generate gyroscopic data. The gyroscopic data is indicative of an orientation of the manned VTOL aerial vehicle 100. The gyroscope 160 is configured to provide the gyroscopic data to the control system 116. In some embodiments, the gyroscope 160 is configured to provide the gyroscopic data to the at least one processor 132. The sensor data comprises the gyroscopic data.

The inertial measurement unit 121 comprises a magnetometer sensor 162. The magnetometer sensor 162 is configured to generate magnetic field data. The magnetic field data is indicative of an azimuth orientation of the manned VTOL aerial vehicle 100. The magnetometer sensor 162 is configured to provide the magnetic field data to the control system 116. In some embodiments, the magnetometer sensor 162 is configured to provide the magnetic field data to the at least one processor 132. The sensor data comprises the magnetic field data.

The sensing system comprises an imaging module 164. The imaging module 164 is configured to generate image data. In particular, the imaging module 164 is configured to generate image data that is associate with the region around the manned VTOL aerial vehicle 100. The imaging module 164 is configured to provide the image data to the control system 116. In some embodiments, the imaging module 164 is configured to provide the image data to the at least one processor 132. The sensor data comprises the image data.

The imaging module 164 comprises a visible spectrum imaging module 166. The visible spectrum imaging module 166 is configured to generate visible spectrum image data that is associated with the region around the manned VTOL aerial vehicle 100. The visible spectrum imaging module 166 is configured to provide the visible spectrum image data to the control system 116. In some embodiments, the visible spectrum imaging module 166 is configured to provide the visible spectrum image data to the at least one processor 132. The image data comprises the visible spectrum image data.

The visible spectrum imaging module 166 comprises a plurality of visible spectrum cameras 167. The visible spectrum cameras 167 are distributed across the body 102 of the manned VTOL aerial vehicle 100. The image data comprises visible spectrum image data. The image data comprises the optical flow data.

The visible spectrum imaging module 166 comprises a forward-facing camera 168. The forward-facing camera 168 is configured to generate image data that is associated with a portion of the region visible in front of a front portion 115 of the manned VTOL aerial vehicle 100. The forward-facing camera 168 is configured to be mounted to the manned VTOL aerial vehicle 100. In some embodiments, the visible spectrum imaging module 166 comprises a plurality of forward-facing cameras 168. Each forward-facing camera 168 may have different (but possibly overlapping) fields of view to capture images of different regions visible in front of the front portion 115 of the manned VTOL aerial vehicle 100.

The visible spectrum imaging module 166 also comprises a downward-facing camera 170. The downward-facing camera 170 is configured to generate image data that is associated with a portion of the region visible below the manned VTOL aerial vehicle 100. The downward-facing camera 170 is configured to be mounted to the manned VTOL aerial vehicle 100. In some embodiments, the visible spectrum imaging module 166 comprises a plurality of downward-facing cameras 170. Each downward-facing camera 170 may have different (but possibly overlapping) fields of view to capture images of different regions visible below the body 102 of the manned VTOL aerial vehicle 100. The downward-facing camera 170 may be referred to as a ground-facing camera. The downward-facing camera 170 may be referred to as a ground-facing camera.

The visible spectrum imaging module 166 comprises a laterally-facing camera 165. The laterally-facing camera 165 is configured to generate image data that is associated with a portion of the region visible to a side of the manned VTOL aerial vehicle 100. The laterally-facing camera 165 is configured to be mounted to the manned VTOL aerial vehicle 100. In some embodiments, the visible spectrum imaging module 116 may comprise a plurality of laterally-facing cameras 165. Each laterally-facing camera 165 may have different (but possibly overlapping) fields of view to capture images of different regions visible laterally of the body 102 of the manned VTOL aerial vehicle 100.

The visible spectrum imaging module 166 comprises a rearward-facing camera 189. The rearward-facing camera 189 is configured to generate image data that is associated with a portion of the region visible behind the manned VTOL aerial vehicle 100. The rearward-facing camera 189 is configured to be mounted to the manned VTOL aerial vehicle 100. In some embodiments, the visible spectrum imaging module 116 may comprise a plurality of rearward-facing cameras 189. Each rearward-facing camera 189 may have different (but possibly overlapping) fields of view to capture images of different regions visible behind the body 102 of the manned VTOL aerial vehicle 100.

The visible spectrum imaging module 166 comprises an event-based camera 173. The event-based camera 173 may be as described in “Event-based Vision: A Survey”, G. Gallego et al., (2020), IEEE Transactions on Pattern Analysis and Machine Intelligence, doi: 10.1109/TPAMI.2020.3008413, the content of which is incorporated herein by reference in its entirety.

The at least one processor 132 may execute the described visual odometry using the event-based camera 173. The at least one processor 132 may execute visual odometry as described in “Real-time Visual-Inertial Odometry for Event Cameras using Keyframe-based Nonlinear Optimization”, Rebecq, Henri & Horstschaefer, Timo & Scaramuzza, Davide, (2017), 10.5244/C.31.16, the content of which is incorporated herein by reference in its entirety.

The imaging module 164 comprises a Light Detection and Ranging (LIDAR) system 174. The LIDAR system 174 is configured to generate LIDAR data associated with at least a portion of the region around the manned VTOL aerial vehicle 100. The image data comprises the LIDAR data. The LIDAR system 174 comprises a LIDAR scanner 177. In particular, the LIDAR system 174 comprises a plurality of LIDAR scanners 177. The LIDAR scanners 177 may be distributed across the body 102 of the manned VTOL aerial vehicle 100. The LIDAR system 174 comprises a solid-state scanning LIDAR sensor 169. The LIDAR system 174 comprises a one-dimensional LIDAR sensor 171. The one-dimensional LIDAR sensor 171 may be in the form of a non-scanning LIDAR sensor.

The imaging module 164 comprises a Radio Detecting and Ranging (RADAR) system 175. The RADAR system 175 is configured to generate RADAR data associated with at least a portion of the region around the manned VTOL aerial vehicle 100. The image data comprises the RADAR data. The RADAR system 175 comprises a RADAR sensor 179. In particular, the RADAR system 175 comprises a plurality of RADAR sensors 179. The RADAR system 175 comprises a radar altimeter 163. The RADAR sensors 179 may be distributed across the body 102 of the manned VTOL aerial vehicle 100.

The RADAR system 175 is configured to generate a range-doppler map. The range-doppler map may be indicative of a position and a speed of the object 113. The sensor data may comprise the range-doppler map.

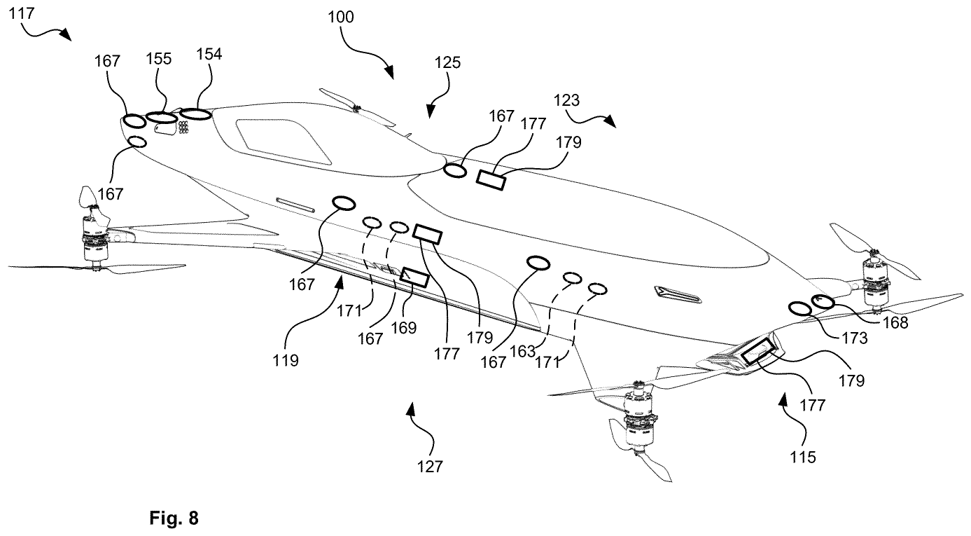

FIG. 8 is a perspective view of the manned VTOL aerial vehicle 100 showing example positioning of a plurality of components of the sensing system 120, according to some embodiments. The manned VTOL aerial vehicle 100 comprises a front portion 115. The manned VTOL aerial vehicle 100 comprises a rear portion 117. The manned VTOL aerial vehicle 100 comprises a first lateral portion 119. The manned VTOL aerial vehicle 100 comprises a second lateral portion 123. The manned VTOL aerial vehicle 100 comprises an upper portion 125. The manned VTOL aerial vehicle 100 comprises a lower portion 127.

The rear portion 117 comprises a plurality of sensors. The sensors may be part of the sensing system 120. For example, as illustrated in FIG. 8, the rear portion 117 comprises a plurality of visible spectrum cameras 167. The rear portion 117 may comprise a rearward-facing camera (e.g. a rearward-facing visible spectrum camera). Alternatively, the rear portion 117 may comprise the downward-facing camera 170. The rear portion 117 comprises the network interface 155. The rear portion comprises the GNSS module 154.

The front portion 115 comprises a plurality of sensors. The sensors may be part of the sensing system 120. For example, as illustrated in FIG. 8, the front portion 115 comprises a visible spectrum camera 167. Specifically, the front portion 115 comprises the forward-facing camera 168. The front portion 115 comprises the event-based camera 173. In some embodiments, the event-based camera 173 comprises the forward-facing camera 168. The front portion 115 comprises a LIDAR scanner 177. The front portion 115 comprise a RADAR sensor 179.

The first lateral portion 119 may be a right-side portion of the manned VTOL aerial vehicle 100. The first lateral portion 119 comprises a visible spectrum camera 167. Specifically, first lateral portion 119 comprises a plurality of visible spectrum cameras 167. One or more of these may be the laterally facing camera 165 previously described. The first lateral portion 119 comprises a solid state scanning LIDAR sensor 169. The first lateral portion 119 comprises a LIDAR scanner 177. The first lateral portion 119 comprises a RADAR sensor 179.

The second lateral portion 123 may be a left-side portion of the manned VTOL aerial vehicle 100. The second lateral portion 123 may comprise the same or similar sensors as the first lateral portion 119.

The upper portion 125 comprises a plurality of sensors. The sensors may be part of the sensing system 120. The upper portion 125 comprises a visible spectrum camera 167. The upper portion 125 comprises a LIDAR scanner 177. The upper portion 125 comprises a RADAR sensor 179.

The lower portion 127 comprises a plurality of sensors. The sensors may be part of the sensing system 120. The lower portion comprises a visible spectrum camera 167. The visible spectrum camera 167 of the lower portion may assist with landing area monitoring and speed estimation using optical flow. The lower portion comprises the one-dimensional LIDAR sensor 171. The lower portion comprises a radar altimeter 163. The radar altimeter 163 may assist with vertical terrain monitoring. The lower portion comprises a one-dimensional LIDAR sensor (not shown). The one-dimensional LIDAR sensor may assist with landing the manned VTOL aerial vehicle 100. The lower portion 127 may also house the power source 130. For example, where the power source 130 comprises one or more batteries, the one or more batteries may be housed in the lower portion 127.

### Track Infrastructure

The aerial vehicle system 101 comprises a central server system 103. The central server system 103 is configured to communicate with the manned VTOL aerial vehicle 100 via the communications network 105. The communications network may be as described herein. Examples of a suitable communications network include a wireless local area network (WLAN) such as Wi-Fi (IEEE 82.15.1) or Zigbee (IEE 802.15.4), a wireless wide area network (WWAN) such as cellular 4G LTE and 5G or another cellular network connection, low power wide area networks (LPWAN) such as SigFox and Lora, Bluetooth™ and/or other near field radio communication.

The central server system 103 comprises at least one central server system processor 220. The at least one central server system processor 220 is configured to be in communication with central server system memory 222.

The central server system 103 also comprises an internal server system communication network (not shown). The internal server system communication network is a wired network. The internal server system communication network connects the at least one central server system processor 220, central server system memory 222 and other components of the central server system 103. The internal server system communication network may comprise a serial link, Ethernet network, a controller area network (CAN) or another network.

The at least one central server system processor 220 is configured to execute central server system program instructions stored in central server system memory 222 to cause the at least one central server system processor 220 to function as described herein.

In some embodiments, the central server system program instructions are in the form of program code. The at least one central server system processor 220 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The central server system program instructions comprise a state estimating module 224.

Central server system memory 222 may comprise one or more volatile or non-volatile memory types. For example, central server system memory 222 may comprise one or more of random access memory (RAM), read-only memory (ROM), electrically erasable programmable read-only memory (EEPROM) or flash memory. Central server memory 222 is configured to store program code accessible by the at least central server system one processor 220. The program code may comprise executable program code modules. In other words, central server system memory 222 is configured to store executable code modules configured to be executable by the at least one central server system processor 220. The executable code modules, when executed by the at least one central server system processor 220 cause the at least one central server system processor 220 to perform certain functionality, as described herein. In the illustrated embodiment, the central server system state estimating module 224 is in the form of program code stored in the central server system memory 222.

The central server system state estimating module 224 is to be understood to be one or more software programs. The central server system state estimating module 224 may, for example, be represented by one or more functions in a programming language, such as C++, C, Python or Java. The resulting source code may be compiled and stored as computer executable instructions on central server system memory 222 that are in the form of the relevant executable code module.

The central server system 103 comprises a central server system communication system 226. The central server system communication system 226 is configured to enable the central server system 103 to communicate with other computing devices. The central server system 103 is configured to communicate with the manned VTOL aerial vehicle 100. In particular, the central server system 103 is configured to communicate with the manned VTOL aerial vehicle 100 using the central server system communication system 226. The central server system communication system 226 may comprise a wireless communication system.

In some embodiments, the central server system 103 is configured to communicate with the manned VTOL aerial vehicle 100 using the central server system communication system 226 and the communications network 105. The communications network 105 may be as previously described. In some embodiments, the central server system 103 is configured to communicate with a plurality of manned VTOL aerial vehicles 100. The central server system 103 may be configured to communicate with each of the plurality of manned VTOL aerial vehicles 100 simultaneously.

The central server system 103 is configured to communicate with an external sensing system 199. In particular, the central server system 103 is configured to communicate with the external sensing system 199 using the central server system communication system 226. In some embodiments, the central server system 103 is configured to communicate with the external sensing system 199 using the central server system communication system 226 and the communications network 105. In some embodiments, the central server system communication system 226 is or includes a wired communication system (i.e. a non-wireless communications system). In these embodiments, the central server system 103 is physically connected to all or part of the external sensing system 199.

The central server system 103 is configured to communicate with the repeater 107. The repeater 107 may be referred to as a trackside repeater. The central server system 103 is configured to communicate with the repeater 107 using the central server system communication system 226. In some embodiments, the central server system 103 is configured to communicate with the repeater 107 using the central server system communication system 226 and the communications network 105.

The central server system 103 is configured to process vehicle data provided to the central server system 103 by the manned VTOL aerial vehicle 100. The central server system 103 is also configured to provide central server data to the manned VTOL aerial vehicle 100.

The central server system 103 may comprise a database 133. Alternatively, the central server system 103 may be in communication with the database 133 (e.g. via a network such as the communications network 105). The database 133 may therefore be a cloud-based database. The central server system 103 is configured to store the vehicle data in the database 133. The central server system 103 is configured to store the central server data in the database 133.

The manned VTOL aerial vehicle 100 is operable to fly around a track 230 (e.g. as shown in FIG. 4). The track 230 may be, or may form part of, the region described herein. The central server system 103 is configured to communicate information regarding the track 230 to the manned VTOL aerial vehicle 100.

The aerial vehicle system 101 may also comprise the repeater 107. The repeater 107 is configured to repeat wireless signals generated by the manned VTOL aerial vehicle 100 and/or the central server system 103 (i.e. the central server system communications system 226) so that the manned VTOL aerial vehicle 100 and the central server system 103 can communicate at further distances than would be enabled without the repeater 107. In some embodiments, the aerial vehicle system 100 comprises a plurality of repeaters 107.

The aerial vehicle system 101 comprises the external sensing system 199. The external sensing system 199 is configured to generate external sensing system data. The external sensing system data may relate to one or more of the manned VTOL aerial vehicle 100 and the region within which the manned VTOL aerial vehicle 100 is located. The external sensing system 199 comprises an external sensing system sensor 228. The external sensing system 199 comprises an external sensing system imaging system 197. In some embodiments, the external sensing system sensor 228 comprises the external sensing system imaging system 197. The external sensing system imaging system 197 is configured to generate external sensing system image data. For example, the external sensing system imaging system 197 may comprise one or more of an external LIDAR system configured to generate external LIDAR data, an external RADAR system configured to generate external RADAR data and an external visible spectrum imaging system configured to generate external visible spectrum image data. The external sensing system 199 comprises an external sensing system sensor 228. The external sensing system sensor 228 may be in the form of the external sensing system imaging system 197.

The external sensing system 199 may comprise one or more of an external LIDAR system, an external RADAR system and an external visible spectrum camera. The external sensing system 199 is configured to generate the external sensing system data based at least in part on inputs received by the external sensing system sensor 228 (e.g. the external sensing system imaging system 197). For example, in some embodiments, the external sensing system 199 is configured to generate point cloud data. This may be referred to as additional point cloud data, as it is additional to the point cloud data generated by the manned VTOL aerial vehicle 100 itself.

The external sensing system 199 is configured to provide the external sensing system data to the central server system 103 and/or the manned VTOL aerial vehicle 100 via the communications network 105 (and the repeater 107 where necessary). The external sensing system 199 may comprise an external sensing system communication system (not shown). The external sensing system communication system may enable the external sensing system 199 to communicate with the central server system 103 and/or the manned VTOL aerial vehicle 100 (e.g. via the communications network 105). Therefore, the external sensing system communication system may enable the external sensing system 199 to provide the external sensing system data to the central server system 103 and/or the manned VTOL aerial vehicle 100.

In some embodiments, the external sensing system 199 may be considered part of the central server system 103. In some embodiments, the central server system 103 may provide the external sensing system data to the manned VTOL aerial vehicle 100 (e.g. via the communications network 105).

In some embodiments, the at least one processor 132 is configured to receive the external LIDAR data, the external RADAR data and the external visible spectrum imaging data. The external LIDAR data may comprise an external region point cloud representing the region.

The aerial vehicle system 101 also comprises one or more other aircraft 109. The other aircraft 109 may be configured to communicate with the manned VTOL aerial vehicle 100 via the communications network 105 and/or the repeater 107. For example, the aerial vehicle system 101 may also comprise a spectator drone 111. The spectator drone 111 may be configured to communicate with the manned VTOL aerial vehicle 100 via the communications network 105 and/or the repeater 107.

In some embodiments, the spectator drone 111 is configured to generate additional image data. The additional image data may comprise additional three-dimensional data. For example, the spectator drone 111 may comprise a drone LIDAR system and/or another drone imaging system capable of generating the additional three-dimensional data. The additional three-dimensional data may be in the form of one or more of a point cloud (i.e. it may be point cloud data) and a depth map (i.e. it may be depth map data). In some embodiments, the additional image data comprises one or more of the additional three-dimensional data, additional visible spectrum image data, additional LIDAR data, additional RADAR data and additional infra-red image data. The spectator drone 111 is configured to provide the additional image data to the central server system 103. The spectator drone 111 may provide the additional image data directly to the central server system 103 using the communications network 105. Alternatively, the spectator drone 111 may provide the additional image data to the central server system 103 via one or more of the repeaters 107. The central server system 103 is configured to store the additional image data in the database 133. The additional image data may be used to generate the three-dimensional model described herein.

In some embodiments, the spectator drone 111 is configured to be a repeater. Therefore, the manned VTOL aerial vehicle 100 may communicate with the central server system 103 via the spectator drone 111. Similarly, the central server system 103 may communicate with the manned VTOL aerial vehicle 100 via the spectator drone 111. As such, the spectator drone 111 may be considered to be a communications relay or a communications backup (e.g. if one of the repeaters 107 fails).

The aerial vehicle system 101 comprises a region mapping system 290. The region mapping system 290 is configured to generate region mapping system data. The region mapping system 290 is configured to generate a three-dimensional model of the region, based on the region mapping system data. The region mapping system 290 may comprise one or more of a region mapping camera system configured to generate visible spectrum region data, a region mapping LIDAR system configured to generate LIDAR region data and a region mapping RADAR system configured to generate RADAR region data. The region mapping system data comprises one or more of the visible spectrum region data, the LIDAR region data and the RADAR region data.

The region mapping system 290 (e.g. at least one region mapping system processor) is configured to determine the three-dimensional model of the region based at least in part on the region mapping system data (e.g. the visible spectrum region data, the LIDAR region data and the RADAR region data). In some embodiments, the region mapping system 290 is configured to process the visible spectrum region data to generate a region depth map. In some embodiments, the region mapping system 290 is configured to process the LIDAR data to determine an initial region point cloud.

The region mapping system 290 generates a three-dimensional occupancy grid based at least in part on the region mapping system data. For example, the region mapping system 290 determines the three-dimensional occupancy grid based at least in part on the region depth map and/or the initial region point cloud. The three-dimensional occupancy grid comprises a plurality of voxels. Each voxel is associated with a voxel probability that is indicative of a probability that a corresponding point of the region comprises an object and/or surface.

The three-dimensional occupancy grid may be an Octomap. In some embodiments, the region mapping system 290 generates the three-dimensional occupancy grid as is described in “OctoMap: An efficient probabilistic 3D mapping framework based on octrees”, Hornung, Armin & Wurm, Kai & Bennewitz, Maren & Stachniss, Cyrill & Burgard, Wolfram, (2013), Autonomous Robots. 34. 10.1007/s10514-012-9321-0 the content of which is incorporated by reference in its entirety.

The region mapping system 290 is configured to provide the three-dimensional model of the region to the manned VTOL aerial vehicle 100 and/or the central server system 103. In some embodiments, the central server system 103 comprises the region mapping system 290.

As previously described, the manned VTOL aerial vehicle 100 may be used in manned VTOL aerial vehicle racing. FIG. 4 is a block diagram of the aerial vehicle system 101, according to some embodiments, showing an example manned VTOL aerial vehicle track 230. The track 230 may correspond to the region described herein. The manned VTOL aerial vehicle 100 is configured to race one or multiple other manned VTOL aerial vehicles 100B-N (i.e. 100B, 100C, . . . , 100N) around the track 230. It will be understood that although the track 230 is shown as two-dimensional, the track 230 may be a three-dimensional track.

As previously described, the external sensing system 199 comprises the external sensing system sensor 228. The external sensing system sensor 228 is configured to generate external sensing system data. The external sensing system data generated by the external sensing system sensor 228 (and therefore the external sensing system 199) may be referred to as external sensing system sensor data. Alternatively, the sensor data generated by the external sensing system sensor 228 (and therefore the external sensing system 199) may be referred to as sensor data.

Referring to FIG. 9, the external sensing system sensor 228 comprises at least one sensor processor 234. The at least one sensor processor 234 is configured to be in communication with sensor memory 236. The external sensing system sensor 228 comprises a sensor module 232. The sensor module 232 may be referred to as an external sensing system sensor module. The sensor module 232 is configured to generate sensor data. The sensor data may be referred to as external sensing system sensor data. The sensor module 232 is configured to communicate with the at least one sensor processor 234. In some embodiments, the sensor module 232 is configured to provide sensor data to the at least one sensor processor 234. In some embodiments, the at least one sensor processor 234 is configured to receive the sensor data from the sensor module 232. In some embodiments, the at least one sensor processor 234 is configured to retrieve the sensor data from the sensor module 232. The at least one sensor processor 234 is configured to store the sensor data in the sensor memory 236. In some embodiments, the at least one sensor processor 234 is configured to provide the sensor data to the central server system 103.

In some embodiments, the sensor module 232 comprises an external LIDAR module. The external LIDAR module is configured to generate external LIDAR data. The external LIDAR data is associated with the region. In particular, the external LIDAR data is associated with the region around the manned VTOL aerial vehicle 100 at a particular point in time.

In some embodiments, the sensor module 232 comprises an external visible spectrum camera. The external visible spectrum camera is configured to generate external sensing system visible spectrum data. The external sensing system visible spectrum data is associated with the region. In particular, the external sensing system visible spectrum data is associated with the region around the manned VTOL aerial vehicle 100 at a particular point in time.

In some embodiments, the external sensing system sensor module 232 comprises an external RADAR module. The external RADAR module is configured to generate external RADAR data. The external RADAR data is associated with the region. In particular, the external RADAR data is associated with the region around the manned VTOL aerial vehicle 100 at a particular point in time.

The at least one sensor processor 234 is configured to execute sensor program instructions stored in sensor memory 236 to cause the external sensing system sensor 228 to function as described herein. In other words, the sensor program instructions are accessible by the at least one sensor processor 234, and are configured to cause the at least one sensor processor 234 to function as described herein.

In some embodiments, the sensor program instructions are in the form of program code. The at least one sensor processor 234 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The sensor program instructions comprise a sensor state estimating module (not shown). The sensor state estimating module is configured to determine a state estimate of an object. For example, the sensor state estimating module is configured to determine an object state estimate of the object 113, or a state estimate of the manned VTOL aerial vehicle 100, as is described in more detail herein.

Sensor memory 236 may comprise one or more volatile or non-volatile memory types. For example, sensor memory 236 may comprise one or more of random access memory (RAM), read-only memory (ROM), electrically erasable programmable read-only memory (EEPROM) or flash memory. Sensor memory 236 is configured to store program code accessible by the at least one sensor processor 234. The program code may comprise executable program code modules. In other words, sensor memory 236 is configured to store executable code modules configured to be executable by the at least one sensor processor 234. The executable code modules, when executed by the at least one sensor processor 234 cause the at least one sensor processor 234 to perform certain functionality, as described herein. In the illustrated embodiment, the sensor state estimating module is in the form of program code stored in the memory 134.

The sensor state estimating module is to be understood to be one or more software programs. It may, for example, be represented by one or more functions in a programming language, such as C++, C, Python or Java. The resulting source code may compiled and stored as computer executable instructions on sensor memory 236 that are in the form of the sensor state estimating module.

Sensor memory 236 is also configured to store a three-dimensional model. The three-dimensional model may be a three-dimensional model of the region. That is, the three-dimensional model may represent the region. The three-dimensional model may have an orientation that corresponds with that of the region, and surface of the three-dimensional model may correspond to surfaces of the region. In some embodiments, the three-dimensional model is a three-dimensional model of the track 230.

In the embodiments illustrated in FIGS. 4 and 9, the external sensing system 199 comprises a plurality of external sensing system sensors 228. The external sensing system sensors 228 are distributed at spaced locations around the track 230. The plurality of external sensing system sensors 228 may comprise a plurality of different types of sensors. For example, the plurality of external sensing system sensors 228 may comprise one or more external sensing system ranged imaging/sensing devices or cameras (e.g. infra-red cameras, visible spectrum cameras, LIDAR sensor modules, RADAR sensor modules etc.) and/or external sensing system audio sensors (e.g. microphones).

### Track Infrastructure and Manned VTOL Aerial Vehicle Operability

As previously described, in some embodiments, the external sensing system 199 is configured to provide external sensing system data to the central server system 103. The central server system 103 is configured to process the external sensing system data.

In some embodiments, the central server system 103 is configured to determine a state estimate. In particular, the at least one central server system processor 220 determines the state estimate. The state estimate is indicative of a state of the manned VTOL aerial vehicle 100 at a particular time. The state estimate may be referred to as a vehicle state estimate. The state estimate is indicative of a position of the manned VTOL aerial vehicle 100. The state estimate is indicative of a velocity of the manned VTOL aerial vehicle 100. The state estimate is indicative of an attitude of the manned VTOL aerial vehicle 100. The state estimate comprises a position estimate.

The state of the manned VTOL aerial vehicle 100 may be indicative of a position of the manned VTOL aerial vehicle 100 within the region. The position estimate is indicative of the position of the manned VTOL aerial vehicle 100 within the region. The position estimate may comprise coordinates that are indicative of a three-dimensional position of the manned VTOL aerial vehicle within the region (e.g. with respect to a fixed reference frame of the region).

The state of the manned VTOL aerial vehicle 100 may be indicative of a velocity of the manned VTOL aerial vehicle 100. The state estimate comprises a speed vector. The speed vector is indicative of the velocity of the manned VTOL aerial vehicle 100. The velocity of the manned VTOL aerial vehicle 100 may comprise a velocity magnitude and a velocity direction. The velocity direction may comprise coordinates that are indicative of a direction in which the manned VTOL aerial vehicle is travelling. The velocity magnitude may be referred to as a speed.

The state of the manned VTOL aerial vehicle 100 may be indicative of an attitude of the manned VTOL aerial vehicle. The state estimate comprises an attitude vector. The attitude vector is indicative of an attitude of the manned VTOL aerial vehicle 100. The at least one central server system processor 220 determines the state estimate based at least in part on the external sensing system data.

The at least one central server system processor 220 determines the state estimate based at least in part on the external sensing system data. Where the external sensing system data comprises external sensing system visible spectrum data, the at least one central server system processor 220 may determine the state estimate based at least in part on the external sensing system visible spectrum data. For example, the at least one central server system processor 220 may execute an object recognition algorithm using the external sensing system visible spectrum data as an input to determine the state estimate.

Where the external sensing system data comprises external LIDAR data, the at least one central server system processor 220 may determine the state estimate based at least in part on the external LIDAR data. For example, the at least one central server system processor 220 may execute an object recognition algorithm using the external LIDAR data as an input to determine the state estimate.

Where the external sensing system data comprises external RADAR data, the at least one central server system processor 220 may determine the state estimate based at least in part on the external RADAR data. For example, the at least one central server system processor 220 may execute an object recognition algorithm using the external RADAR data as an input to determine the state estimate.

In some embodiments, the central server system 103 is configured to determine a state estimate confidence metric. In particular, the at least one central server system processor 220 determines the state estimate confidence metric. The state estimate confidence metric is indicative of an error associated with the state estimate. The state estimate confidence metric may be referred to as a vehicle state estimate confidence metric.

The at least one central server system processor 220 determines the state estimate confidence metric based at least in part on the external sensing system data. The at least one processor 132 determines the state estimate confidence metric based at least in part on one of the inputs used to determine the state estimate (e.g. the external sensing system data). For example, the at least one central server system processor 220 may determine the state estimate confidence metric based at least in part on an error associated with one or more of the external sensing system visible spectrum data, the external LIDAR data and external RADAR data.

In some embodiments, the at least one central server system processor 220 determines the state estimate and the state estimate confidence metric by using the external sensing system data (e.g. the external image data) as an input of a convolutional neural network.

In some embodiments, the central server system 103 is configured to determine an object state estimate. In particular, the at least one central server system processor 220 determines the object state estimate. The object state estimate is indicative of a position of the object 113. The object state estimate is indicative of a velocity of the object 113. The object state estimate is indicative of an attitude of the object 113. The object state estimate comprises an object position estimate. The object position estimate is indicative of the position of the object 113 within the region. The object state estimate comprises an object speed vector. The object speed vector is indicative of the velocity of the object 113. The velocity of the object 113 may comprise an object velocity magnitude and an object velocity direction. The object velocity magnitude may be referred to as an object speed. The object state estimate comprises an object attitude vector. The object attitude vector is indicative of an attitude of the object 113. The at least one central server system processor 220 determines the object state estimate based at least in part on the external sensing system data.

The at least one central server system processor 220 determines the object state estimate based at least in part on the external sensing system data. Where the external sensing system data comprises external sensing system visible spectrum data, the at least one central server system processor 220 may determine the object state estimate based at least in part on the external sensing system visible spectrum data. For example, the at least one central server system processor 220 may execute an object recognition algorithm using the external sensing system visible spectrum data as an input to determine the object state estimate.

Where the external sensing system data comprises external LIDAR data, the at least one central server system processor 220 may determine the object state estimate based at least in part on the external LIDAR data. For example, the at least one central server system processor 220 may execute an object recognition algorithm using the external LIDAR data as an input to determine the object state estimate.

Where the external sensing system data comprises external RADAR data, the at least one central server system processor 220 may determine the object state estimate based at least in part on the external RADAR data. For example, the at least one central server system processor 220 may execute an object recognition algorithm using the external RADAR data as an input to determine the object state estimate.

The visible spectrum image data may be used as an input to a Deep Neural Network. The at least one central server system processor 220 detects, localises and/or classifies the object 113 based at least in part on the visible spectrum image data.

The at least one central server system processor 220 may perform image segmentation to detect, localise and/or classify the object 113. The image segmentation may be based on a pixel value threshold, edge detection, clustering or a convolutional neural network (CNN), for example.

The at least one central server system processor 220 may use an artificial neural network (ANN) to detect, localise and/or classify the object 113. The ANN may be in the form of a CNN-based architecture that may include one or more of an input layer, convolutional layers, fully connected layers, pooling layers, binary step activation functions, linear activation functions and non-linear activation functions.

For example, the at least one central server system processor 220 may use a neural network to detect, localise and/or classify the object 113 as described in “Detection of a Moving UAV Based on Deep Learning-Based Distance Estimation”, Lai, Ying-Chih & Huang, Zong-Ying, (2020), Remote Sensing, 12(18), 3035, the content of which is incorporated herein by reference in its entirety.

In some embodiments, the central server system 103 is configured to determine an object state estimate confidence metric. In particular, the at least one central server system processor 220 determines the object state estimate confidence metric. The object state estimate confidence metric is indicative of a degree of error associated with the object state estimate.

The at least one central server system processor 220 determines the object state estimate confidence metric based at least in part on the external sensing system data. The at least one central server system processor 220 determines the object state estimate confidence metric based at least in part on one of the inputs used to determine the object state estimate (e.g. the external sensing system data). For example, the at least one central server system processor 220 may determine the object state estimate confidence metric based at least in part on an error associated with one or more of the external sensing system visible spectrum data, the external LIDAR data and external RADAR data. In other words, in some embodiments the at least one central server system processor 220 determines the object state estimate confidence metric based at least in part on the external sensing system data.

In some embodiments, the at least one central server system processor 220 determines the object state estimate and the object state estimate confidence metric by using the external sensing system data (e.g. the external image data) as an input of a convolutional neural network.

In some embodiments, the object state estimate comprises an object classification. The object classification is indicative of a class of the object 113. For example, the object 113 may be classified as a bird, an aerial vehicle, airborne debris, etc.

As previously described, the central server system 103 is configured to store a three-dimensional model. In particular, the central server system memory 222 is configured to store the three-dimensional model. The three-dimensional model represents the region. The three-dimensional model may be pre-defined. The three-dimensional model is a three-dimensional virtual model.

The at least one central server system processor 220 is configured to modify the three-dimensional model, based at least in part on the object state estimate. The at least one central server system processor 220 is configured to modify the three-dimensional model based at least in part on the object state estimate confidence metric. The at least one central server system processor 220 is therefore configured to determine a modified three-dimensional model, based at least in part on the object state estimate and/or the object state estimate confidence metric.

The at least one central server system processor 220 is configured to modify the three-dimensional model, based at least in part on the state estimate. The at least one central server system processor 220 is configured to modify the three-dimensional model based at least in part on the state estimate confidence metric. The at least one central server system processor 220 is therefore configured to determine a modified three-dimensional model, based at least in part on the state estimate and/or the state estimate confidence metric.

For example, when the manned VTOL aerial vehicle 100 participates in a race where there is a crash, or a desired change to the track 230 mid-race, the at least one central server system processor 220 may detect the crash (by the previously described object detection) and modify the three-dimensional model representing the region such that a section of the track 230 is or becomes a no-fly zone or the section of the track is reduced or altered to account for a virtual object bubble centred on the detected crash.

In some embodiments, the at least one central server system processor 220 is configured to determine an alert. The at least one central server system processor 220 determines the alert based at least in part on the state estimate. The at least one central server system processor 220 determines the alert based at least in part on the state estimate confidence metric. The at least one central server system processor 220 determines the alert based at least in part on the object state estimate. The at least one central server system processor 220 determines the alert based at least in part on the object state estimate confidence metric. For example, when the manned VTOL aerial vehicle 100 participates in a race where there is a crash, or a desired change to the track 230 mid-race, the at least one central server system processor 220 may detect the crash (by the previously described object detection) and generate an alert to indicate that section of the track 230 is a no-fly zone or that that section contains a course alteration.

In some embodiments, rather than the central server system 103 determining the state estimate and/or the state estimate confidence metric, the external sensing system sensor 228 determines the state estimate and/or the state estimate confidence metric. The at least one sensor processor 234 may determine the state estimate as described with reference to the central server system 103. The at least one sensor processor 234 may determine the state estimate confidence metric as described with reference to the central server system 103. That is, the at least one sensor processor 234 may determine the state estimate and/or the state estimate confidence metric based at least in part on the external sensing system data.

In these embodiments, the external sensing system sensor 228 is configured to provide the state estimate to the central server system 103. The sensor 228 is configured to provide the state estimate confidence metric to the central server system 103. The external sensing system sensor 228 may, for example, provide the state estimate and the state estimate confidence metric to the central server system via the communications network 105. Alternatively, the external sensing system sensor 228 may provide the state estimate and/or the state estimate confidence metric directly to the manned VTOL aerial vehicle using the communications network 105.

In some embodiments, rather than the central server system 103 determining the object state estimate and/or the object state estimate confidence metric, the external sensing system sensor 228 determines the object state estimate and/or the object state estimate confidence metric. The at least one sensor processor 234 may determine the object state estimate as described with reference to the central server system 103. The at least one sensor processor 234 may determine the object state estimate confidence metric as described with reference to the central server system 103. That is, the at least one sensor processor 234 may determine the object state estimate and/or the object state estimate confidence metric based at least in part on the external sensing system data.

In these embodiments, the external sensing system sensor 228 is configured to provide the object state estimate to the central server system 103. The external sensing system sensor 228 is configured to provide the object state estimate confidence metric to the central server system 103. The external sensing system sensor 228 may, for example, provide the object state estimate and the object state estimate confidence metric to the central server system 103 via the communications network 105. Alternatively, the external sensing system sensor 228 may provide the object state estimate and/or the object state estimate confidence metric directly to the manned VTOL aerial vehicle using the communications network 105.

In some embodiments, the external sensing system sensor 228 is configured to store the three-dimensional model. In particular, the sensor memory 236 is configured to store the three-dimensional model.

The at least one sensor processor 234 is configured to modify the three-dimensional model, based at least in part on the object state estimate. The at least one sensor processor 234 is configured to modify the three-dimensional model based at least in part on the object state estimate confidence metric. The at least one sensor processor 234 is therefore configured to determine a modified three-dimensional model, based at least in part on the object state estimate and/or the object state estimate confidence metric.

The at least one sensor processor 234 is configured to modify the three-dimensional model, based at least in part on the state estimate. The at least one sensor processor 234 is configured to modify the three-dimensional model based at least in part on the state estimate confidence metric. The at least one sensor processor 234 is therefore configured to determine a modified three-dimensional model, based at least in part on the state estimate and/or the state estimate confidence metric.

For example, when the manned VTOL aerial vehicle 100 participates in a race where there is a crash, or a desired change to the track 230 mid-race, the at least one sensor processor 234 may detect the crash (by the previously described object detection) and modify the three-dimensional model representing the region such that section of the track 230 is a no-fly zone.

In some embodiments, the at least one sensor processor 234 is configured to determine an alert. The at least one sensor processor 234 determines the alert based at least in part on the object state estimate. The at least one sensor processor 234 determines the alert based at least in part on the object state estimate confidence metric. For example, when the manned VTOL aerial vehicle 100 participates in a race where there is a crash, or a desired change to the track 230 mid-race, the at least one sensor processor 234 may detect the crash (by the previously described object detection) and generate an alert to indicate that section of the track 230 is a no-fly zone or includes a course alteration.

In some embodiments, the central server system 103 is configured to transmit wireless information to the manned VTOL aerial vehicle 100 using the central server system communication system 226. In some embodiments, one or more of the external sensing system sensors 228 are configured to transmit wireless information to the manned VTOL aerial vehicle 100.

The wireless information comprises the object state estimate. The wireless information comprises the object state estimate confidence metric. The wireless information comprises the state estimate. The wireless information comprises the state estimate confidence metric. The wireless information comprises the three-dimensional model. The wireless information comprises the modified three-dimensional model. The wireless information comprises the alert. The manned VTOL aerial vehicle 100 is configured to receive the wireless information using the communication system 122.

In some embodiments, the manned VTOL aerial vehicle 100 is configured to transmit vehicle data using the communication system 122. In particular, the manned VTOL aerial vehicle 100 is configured to wirelessly transmit vehicle data using the communication system 122. The central server system 103 is configured to receive the vehicle data using the central server system communication system 226. In particular, the at least one central server system processor 220 is configured to receive the vehicle data using the central server system communication system 226. In some embodiments, one or more of the external sensing system sensors 228 are configured to receive the vehicle data.

In some embodiments, the repeater 107 is configured to receive the wireless information transmitted by the central server system 103. The repeater 107 is configured to re-transmit the wireless information. The repeater 107 may re-transmit the wireless information at a higher power than it was received, thereby amplifying the wireless signal comprising the wireless information. Thus, the repeater 107 enables the central server system 103 to provide the wireless information to the manned VTOL aerial vehicle from an extended distance.

The repeater 107 is configured to receive the vehicle data transmitted by the manned VTOL aerial vehicle 100. The repeater 107 is configured to re-transmit the vehicle data. The repeater may re-transmit the vehicle data at a higher power than it was received, thereby amplifying the wireless signal comprising the vehicle data. Thus, the repeater 107 enables the manned VTOL aerial vehicle to provide the vehicle data to the manned VTOL aerial vehicle from an extended distance.

The at least one processor 132 of the manned VTOL aerial vehicle 100 may control the propulsion system 106 of the manned VTOL aerial vehicle 100 to avoid the object 113 (or the plurality of objects 113, where relevant). In particular, the at least one processor 132 may control the propulsion system 106 of the manned VTOL aerial vehicle 100 to avoid the object 113 based at least in part on the state estimate received from the central server system 103. The at least one processor 132 may control the propulsion system 106 of the manned VTOL aerial vehicle 100 to avoid the object 113 whilst remaining within the region.

The at least one processor 132 may control the propulsion system 106 of the manned VTOL aerial vehicle 100 to avoid the object 113 based at least in part on the state estimate confidence metric.

The at least one processor 132 may control the propulsion system 106 of the manned VTOL aerial vehicle 100 to avoid the object 113 based at least in part on the object state estimate.

The at least one processor 132 may control the propulsion system 106 of the manned VTOL aerial vehicle 100 to avoid the object 113 based at least in part on the object state estimate confidence metric.

The at least one processor 132 controls the propeller drive systems 114 to rotate the propellers as necessary to control the manned VTOL aerial vehicle in accordance with a control vector. In some embodiments, the at least one processor 132 controls the propulsion system 106 of the manned VTOL aerial vehicle 100 to avoid the object 113 based at least in part on the three-dimensional model or the modified three-dimensional model.

The at least one processor 132 determines a control vector used to control the propulsion system 106 based at least in part on one or more of the state estimate, the state estimate confidence metric, the object state estimate and the object state estimate confidence metric. In some embodiments, the at least one processor 132 determines the control vector based at least in part on the three-dimensional model or the modified three-dimensional model. In some embodiments, the at least one processor 132 controls the propulsion system 106 of the manned VTOL aerial vehicle 100 such that the manned VTOL aerial vehicle 100 avoids colliding with the object, based at least in part on the updated state estimate and the object state estimate.

The at least one processor 132 may provide an alert to the pilot. The alert may be in the form of a warning. The at least one processor 132 may determine the alert based at least in part on the sensor data. The at least one processor 132 may display the alert using the display of the cockpit 104. In some embodiments, the display is in the form of a heads-up display. In these embodiments, the at least one processor 132 may display the alert using the heads-up display. In some embodiments, the alert may comprise an audio output. In some embodiments, the alert may comprise haptic feedback, for example, through a seat of the cockpit 104 or the pilot-operable controls 118. The at least one processor may execute the cockpit warning system 161 to determine and/or display the alert.

As previously described, in some embodiments, the manned VTOL aerial vehicle 100 is configured to transmit some or all of the vehicle data using the communication system 122. For example, the manned VTOL aerial vehicle 100 is configured to transmit some or all of the vehicle data to the central server system 103 over the communications network 105 using the communication system 122. Similarly, the central server system 103 is configured to transmit some or all of the central server data using the central server system communication system 226. For example, the central server system 103 is configured to transmit some or all of the central server data to the manned VTOL aerial vehicle 100 over the communications network 105 using the central server system communication system 226.

In some embodiments, the vehicle data comprises one or more of the state estimate and the state estimate confidence metric. The vehicle data comprises one or more of the object state estimate and the object state estimate confidence metric. The vehicle data comprises classification data. The classification data comprises the object classification. The vehicle data comprises identification information. The identification information comprises an identifier that is associated with the manned VTOL aerial vehicle 100. For example, the identification information may comprise a unique identification number that is associated with the manned VTOL aerial vehicle 100. In some embodiments, the vehicle data comprises the sensor data.

In some embodiments, the central server data comprises one or more of the state estimate and the state estimate confidence metric. The central server data comprises one or more of the object state estimate and the object state estimate confidence metric. The central server data comprises classification data. The classification data comprises the object classification. In some embodiments, the central server system 103 is configured to classify the object 113 based at least in part on the external sensing system data. Thus, the central server system 103 may determine the object classification.

The central server data comprises identification information. The identification information comprises an identifier that is associated with the manned VTOL aerial vehicle 100. For example, the identification information may comprise a unique identification number that is associated with the manned VTOL aerial vehicle 100. In some embodiments, the central server system 103 is configured to determine the identification information based at least in part on the external sensing system data. The central server system 103 may determine one or more characteristics associated with the manned VTOL aerial vehicle 100 based at least in part on the external sensing system data. The characteristics may comprise one or more of an estimated length, an estimated width or an estimated depth of the manned VTOL aerial vehicle 100, for example, and may be used by the central server system 103 to determine the identification information.

### Central Server System 103 Additional Functionality

As previously described, the sensing system 120 comprises different types of sensors. Furthermore, the external sensing system 199 comprises a plurality of external sensing system sensors 228. The plurality of external sensing system sensors 228 comprises multiple different types of external sensing system sensors 228.

A particular sensor of the external sensing system sensors 228 may not provide enough information to enable determination of the state estimate, state estimate confidence metric, object state estimate or object state estimate confidence metric described herein. For example, where the external sensing system 199 comprises an external sensing system sensor 228 in the form of a visible spectrum camera, visible spectrum image data provided by the visible spectrum camera may only be usable to provide information relating to the azimuth and elevation of an object within a field of view of the visible spectrum camera (e.g. the object 113 or the manned VTOL aerial vehicle 100). That is, the visible spectrum image data provided by the visible spectrum camera may not enable accurate determination of a range value associated with the object within the field of view of the visible spectrum camera.

In some embodiments, for example, for known objects, machine learning and/or pixel size/distance correlation algorithms may be used to estimate a range value associated with the object within the field of view of the visible spectrum camera. These algorithms may, however, be limited to certain sets of ranges and/or accuracies.

In some embodiments, the central server system 103 is configured to determine one or more aspects associated with the aerial vehicle system 101 based on data obtained from a plurality of the external sensing system sensors 228, a plurality of the sensors of the sensing system 120 or a combination of one or more of the external sensing system sensors 228 and one or more of the sensors of the sensing system 120. The aspects associated with the aerial vehicle system 101 comprise the state estimate, the state estimate confidence metric, the object state estimate and the object state estimate confidence metric. In some embodiments, the aspects associated with the aerial vehicle system 101 comprise the position estimate, the speed vector, the attitude vector, the object position estimate, the object speed vector, the object attitude vector and/or an angular rate estimate. In other words, the central server system 103 may determine the one or more aspects associated with the aerial vehicle system 101, the manned VTOL aerial vehicle 100 and/or the object 113 using a plurality of partial data sources that, together, provide sufficient data to determine the relevant aspect. In particular, the at least one central server system processor 220 may execute the central server system program instructions to determine the aspect(s) associated with the aerial vehicle system 101.

In some embodiments, the central server system 103 is configured to determine a partial state estimate. In particular, the at least one central server system processor 220 determines the partial state estimate. The partial state estimate comprises part of the parameters of the state estimate. For example, the partial state estimate may comprise the position estimate alone, the speed vector alone, the attitude vector alone or a combination of two of these. Alternatively, the partial state estimate may comprise part of the parameters that the position estimate, speed vector and/or attitude vector comprise. For example, where the speed vector indicates a velocity of the manned VTOL aerial vehicle 100 in three-dimensional space, the partial state estimate may comprise a partial speed vector that is indicative of a velocity of the manned VTOL aerial vehicle 100 in a one-dimension space, or in a two-dimensional space (i.e. a plane). The partial state estimate may therefore comprise one or more of a partial position estimate, a partial speed vector and a partial attitude vector.

As described herein, the state estimate comprises the position estimate, the speed vector and the attitude vector. In some cases, the external sensing system data available to the central server system 103 may be insufficient to enable the central server system 103 to determine each of the position estimate, the speed vector and the attitude vector, and therefore the state estimate. In many cases however, determining even a sub-set of the parameters of the state estimate (i.e. the partial state estimate) can provide useful information.

For example, as previously described, where the external sensing system 199 comprises an external sensing system sensor 228 in the form of a visible spectrum camera, the visible spectrum image data provided by the visible spectrum camera may only be usable to provide information relating to the azimuth and elevation of an object within a field of view of the visible spectrum camera. In this case, if no, or insufficient, additional information is available to the central server system 103 to enable determination of the state estimate, the central server system 103 can determine the partial state estimate (which may also be referred to as an incomplete state estimate). If the visible spectrum camera is positioned at a known location relative to an obstacle or track infrastructure (e.g. with known location), the partial state estimate determined based on the provided visible spectrum image data can be sufficient to validate one or more safety parameters associated with the manned VTOL aerial vehicle 100 (e.g. determining whether an observed velocity in a particular direction will result in collision with the object or track infrastructure of known position).

In some embodiments, the central server system 103 is configured to determine a partial object state estimate. In particular, the at least one central server system processor 220 determines the partial object state estimate. The partial object state estimate comprises part of the parameters that the object state estimate comprises. For example, the partial object state estimate may comprise the object position estimate alone, the object speed vector alone, the object attitude vector alone or a combination of two of these. Alternatively, the partial object state estimate may comprise part of the parameters that the object position estimate, object speed vector and/or object attitude vector comprise. For example, where the object speed vector indicates a velocity of the object 113 in three-dimensional space, the partial object state estimate may comprise a partial object speed vector that is indicative of a velocity of the object 113 in a one-dimension space, or in a two-dimensional space (i.e. a plane). The partial object state estimate may therefore comprise one or more of a partial object position estimate, a partial object speed vector and a partial object attitude vector.

In some embodiments, the visible spectrum data generated by the external sensing system 199 can be used to determine a partial object position estimate. Similarly, the visible spectrum data generated by the external sensing system 199 can be used to determine a partial speed vector. The partial object position estimate and the partial speed vector may be in a two-dimensional image plane of the relevant visible spectrum camera of the external sensing system 199. The central control system 103 is configured to determine one or more of an azimuth estimate, an altitude estimate and an angular speed estimate of the object within a frame of reference corresponding to the two-dimensional image plane of the relevant visible spectrum camera of the external sensing system 199. In this case, the partial object state estimate is lacking a range estimation, however, it can still be useful in controlling the propulsion of the manned VTOL aerial vehicle 100 to avoid the object.

As described herein, the object state estimate comprises the object position estimate, the object speed vector and the object attitude vector. In some cases, the external sensing system data available to the central server system 103 may be insufficient to enable the central server system 103 to determine each of the object position estimate, the object speed vector and the object attitude vector, and therefore the object state estimate. In many cases however, determining even a sub-set of the parameters of the object state estimate (i.e. the partial object state estimate) can provide useful information.

For example, as previously described, where the external sensing system 199 comprises an external sensing system sensor 228 in the form of a visible spectrum camera, the visible spectrum image data provided by the visible spectrum camera may only be usable to provide information relating to the azimuth and elevation of the object 113 when it is within a field of view of the visible spectrum camera. In this case, if no, or insufficient, additional information is available to the central server system 103 to enable determination of the object state estimate, the central server system 103 can determine the partial object state estimate (which may also be referred to as an incomplete object state estimate) which is still useful. If the visible spectrum camera is positioned such that it provides an appropriate view point, or if it is positioned at a known location relative to the object 113 or track infrastructure (e.g. with known location), the partial object state estimate determined based on the provided visible spectrum image data can be sufficient to validate one or more safety parameters associated with the object 113 (e.g. determining whether an observed velocity in a particular direction will result in the object 113 colliding with track infrastructure of known position or the manned VTOL aerial vehicle 100). The central server system 103 is configured to transmit the partial state estimate to the manned VTOL aerial vehicle 100.

Different types of external sensing system sensors 228 may generate external sensing system data at different frequencies. For example, in some embodiments, the external sensing system 199 comprises a first external sensing system sensor configured to generate first external sensing system sensor data at a first frequency. The external sensing system 199 also comprises a second external sensing system sensor configured to generate second external sensing system sensor data at a second frequency. Furthermore, there may be a time delay associated with each respective external sensing system sensor 228 of the external sensing system 199. The first external sensing system sensor data may therefore be associated with a first time delay. The second external sensing system sensor data may be associated with a second time delay. The first time delay may be different (i.e. greater or less than) the second time delay.

As a result of this, the central server system 103 is configured to autonomously perform data fusion of received sensor tracks (e.g. the first external sensing system sensor data and the second external sensing system sensor data). In some embodiments, the central server system 103 is configured to extrapolate sensor tracks (e.g. the object state estimate) so that the central server system 103 can process incoming data (e.g. vehicle data, external sensing system data) at the same time, even though different sensor tracks of the incoming data may be received with varying delays and at different rates.

The central server system 103 is configured to merge sensor tracks (e.g. the first external sensing system sensor data and the second external sensing system sensor data) based on one or more parameters. For example, where the sensor tracks relate to the object 113, the central server system 103 may merge the sensor tracks based on classification data (e.g. the type of object). In some embodiments, the central server system 103 may merge the sensor tracks based on identification information (e.g. the previously described identifier that is associated with the manned VTOL aerial vehicle 100). In some embodiments, the central server system 103 may merge the sensor tracks based on the state estimate and the state estimate confidence metric, or the object state estimate and the object state estimate confidence metric.

Sensor data from two or more sensors (e.g. one or more sensors of the sensing system 120 and/or one or more sensors of the external sensing system sensor 228) can be merged for processing as described herein. In some embodiments, the central server system 103 is configured to unmerge sensor tracks if they don't satisfy track differentiation criteria. In some embodiments, the track differentiation criteria comprises distance, a speed difference or a maximum distance between sensor lines of sight. For example, where at least two of the sensors can estimate a three-dimensional position, the differentiation criteria can be a distance. Alternatively, where at least two of the sensors can estimate a position and a velocity, the differentiation criteria can be a speed difference. Alternatively, where at least two of the sensors can estimate azimuth and elevation information, the differentiation criteria can be a maximum distance between the line of sight of the two sensors.

In some scenarios, there may be transmission losses associated with sensor data and/or external sensing system data. The sensor data and/or external sensing system data may also be received by the central server system 103 at an abnormal time, or may be associated with an abnormal time (e.g. having a timestamp that is inconsistent with some aspect of the data). For example, the manned VTOL aerial vehicle 100 can be piloted to regions where there is poor network connectivity, for example, regions where the GNSS module 154 is unable to communicate with the necessary satellites/network infrastructure to determine GNSS data, or where the communication is delayed due to an obstruction of the signal.

In cases such as this, the central server system 103 is configured to consider a plurality of scenarios (e.g. with respect to the state estimate of the manned VTOL aerial vehicle 100) between two consecutive state estimates. A trajectory may be associated with each of the plurality of scenarios. Movements associated with the trajectories may be compared to other data sources such as the accelerometer data provided by the accelerometer 158. The central server system 103 may determine a most probable trajectory or most probable trajectories based at least in part on the two consecutive state estimates and the data from the other data sources. In some embodiments, known information about the region can be used to weight the most probable trajectories when absolute localisation data or the sensor data is not sufficient to enable determination of a state estimate with enough confidence. For example, a trajectory probability may be associated with each of the most probable trajectories. The trajectory probabilities may be determined based at least in part on known information about the region (e.g. the three-dimensional model of the region).

In some embodiments, the communications network 105 is configured to support the localisation of the manned VTOL aerial vehicle 100. A localisation of the manned VTOL aerial vehicle 100 may comprise the state estimate, or a part thereof (e.g. the position estimate, speed vector and/or attitude vector). The three-dimensional model described herein may include infrastructure of the communications network 105 or infrastructure such as the repeaters 107. One or more components of the communications network 105 or the central server system communication system 226 may be associated with pre-defined position(s) within the three-dimensional model. The three-dimensional model may define a global coordinate system. The global coordinate system comprises a global coordinate system origin with respect to which positions within the three-dimensional model are defined. Therefore, the components of the communications network 105 or the central server communication system 226 may be associated with positions of the global coordinate system.

As previously described, the manned VTOL aerial vehicle 100 is configured to communicate with the central server system 103 using the communications network 105. The central server system 103 is configured to use data associated with the manned VTOL aerial vehicle 100 that is provided by the communications network 105 or the central server system communications network 226 when determining position, velocity, attitude, angular rate and/or other estimates associated with the manned VTOL aerial vehicle 100. The data associated with the manned VTOL aerial vehicle 100 may be referred to as localisation data, and may comprise one or more of the data types described herein (e.g. GNSS data, accelerometer data etc.).

In some embodiments, the central server system 103 is configured to use the localisation data provided by the communications network 105 or the central server system communications network 226 when determining the state estimate and/or state estimate confidence metric. As the communications network 105 includes communications infrastructure to enable communication with the manned VTOL aerial vehicle 100, where the manned VTOL aerial vehicle 100 is able to communicate with one or more components of the communications network 105, the central server system 103 can use Round Trip Time (RTT) determination, or techniques such as Time Differential of Arrival (TDOA) to determine and/or improve the state estimate and/or state estimate confidence metric. In some embodiments, this localisation data can complement the GNSS data to improve the state estimate and/or state estimate confidence metric. In some embodiments, this localisation data can be used to replace the GNSS data to improve the state estimate and/or state estimate confidence metric if the GNSS data is not available. The sensor data may comprise the localisation data, the RTT determination, TDOA data or other localisation data. The external sensing system data may comprise the localisation data, the RTT determination, TDOA data or other localisation data.

### Alternative Aerial Vehicle System

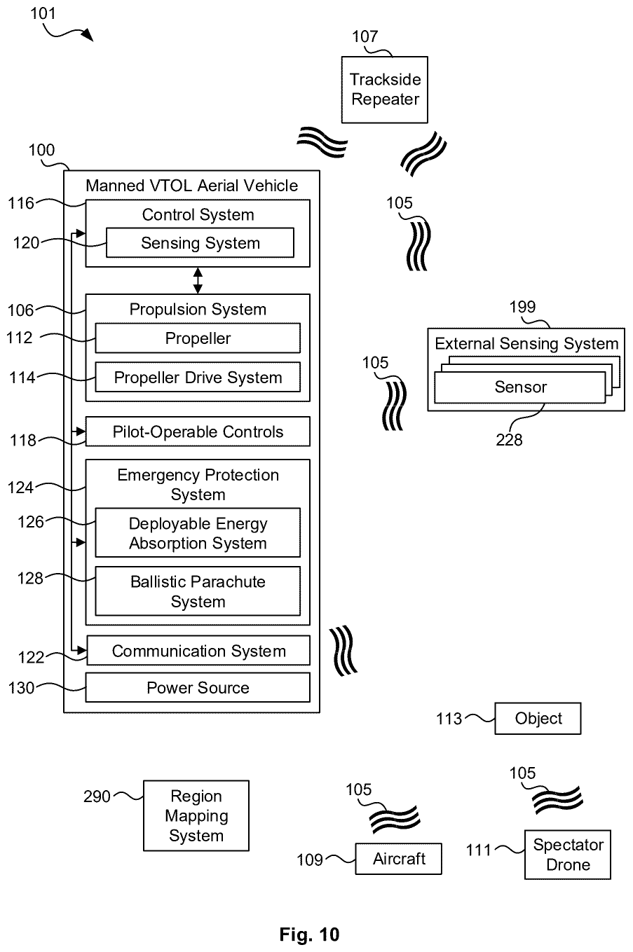

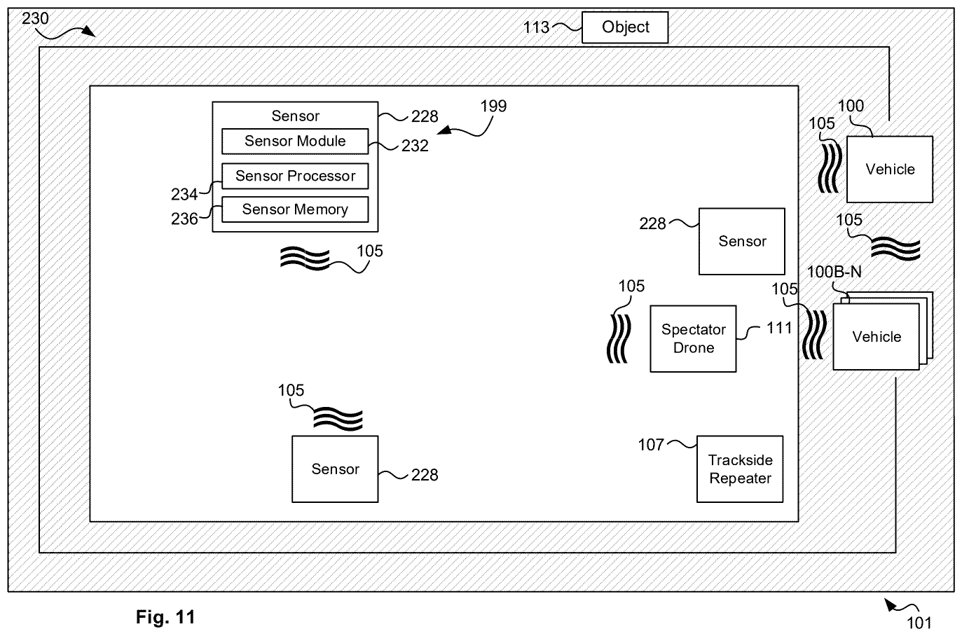

FIGS. 10 and 11 illustrate an alternative aerial vehicle system 101, according to some embodiments. The aerial vehicle system 101 of FIGS. 10 and 11 comprises the manned VTOL aerial vehicle 100. The manned VTOL aerial vehicle 100 may be as described herein. The aerial vehicle system 101 of FIGS. 10 and 11 comprises an external sensing system 199.

The external sensing system 199 comprises an external sensing system sensor 228. The external sensing system sensor 228 is configured to generate external sensing system data. In particular, a sensor module 232 of the external sensing system sensor 228 is configured to generate the external sensing system data. The external sensing system data generated by the external sensing system sensor 228 (and therefore the external sensing system 199) may be referred to as external sensing system sensor data. Alternatively, the sensor data generated by the sensor 228 (and therefore the external sensing system 199) may be referred to as sensor data.

The external sensing system sensor 228 comprises at least one sensor processor 234. The at least one sensor processor 234 is configured to be in communication with sensor memory 236. The sensor 228 comprises the sensor module 232. The sensor module 232 may be referred to as an external sensing system sensor module. The sensor module 232 is configured to generate the external sensing system sensor data. The external sensing system sensor data may be referred to as sensor data. The sensor module 232 is configured to communicate with the at least one sensor processor 234. The external sensing system sensor 228, at least one sensor processor 234, sensor memory 238 and the sensor module 232 may be as previously described.

In some embodiments, the sensor module 232 comprises an external LIDAR module. The external LIDAR module is configured to generate external LIDAR data. The external LIDAR data is associated with the region. In particular, the external LIDAR data is associated with the region around the manned VTOL aerial vehicle 100 at a particular point in time.

In some embodiments, the sensor module 232 comprises an external visible spectrum imaging module. The external visible spectrum imaging module is configured to generate external sensing system visible spectrum data. The external sensing system visible spectrum data is associated with the region. In particular, the external sensing system visible spectrum data is associated with the region around the manned VTOL aerial vehicle 100 at a particular point in time.

In some embodiments, the external sensing system sensor module 232 comprises an external RADAR module. The external RADAR module is configured to generate external RADAR data. The external RADAR data is associated with the region. In particular, the external RADAR data is associated with the region around the manned VTOL aerial vehicle 100 at a particular point in time.

The at least one sensor processor 234 is configured to execute sensor program instructions stored in sensor memory 236 to cause the external sensing system sensor 228 to function as described herein. In other words, the sensor program instructions are accessible by the at least one sensor processor 234, and are configured to cause the at least one sensor processor 234 to function as described herein.

The external sensing system sensor 228 comprises a sensor wireless communication module (not shown). The sensor wireless communication module enables the external sensing system sensor 228 to communicate with the manned VTOL aerial vehicle, for example, using the communications network 105.

The aerial vehicle system 101 of FIGS. 10 and 11 comprises a plurality of external sensing system sensors 228. Each external sensing system sensor 228 is configured to communicate with the manned VTOL aerial vehicle 100 over the communications network 105 as previously described. Each external sensing system sensor 228 is also configured to communicate with other external sensing system sensors 228 of the aerial vehicle system 101. The external sensing system sensors 228 are configured to communicate with other external sensing system sensors 228 using the communications network 105. This may be, for example, wireless communication.

In this embodiment, rather than providing the external sensing system data to a central server system, the external sensing system sensors 228 provide the external sensing system data directly to the manned VTOL aerial vehicle 100.

In some embodiments, the external sensing system 199 is configured to determine a state estimate. In particular, the at least one sensor processor 234 determines the state estimate. The state estimate is indicative of a state of the manned VTOL aerial vehicle 100, as previously described. The state estimate may be referred to as a vehicle state estimate. The at least one sensor processor 234 determines the state estimate based at least in part on the external sensing system data.

The at least one sensor processor 234 determines the state estimate based at least in part on the external sensing system data. Where the external sensing system data comprises external sensing system visible spectrum data, the at least one sensor processor 234 may determine the state estimate based at least in part on the external sensing system visible spectrum data. For example, the at least one sensor processor 234 may execute an object recognition algorithm using the external sensing system visible spectrum data as an input to determine the state estimate.

Where the external sensing system data comprises external LIDAR data, the at least one sensor processor 234 may determine the state estimate based at least in part on the external LIDAR data. For example, the at least one sensor processor 234 may execute an object recognition algorithm using the external LIDAR data as an input to determine the state estimate.

Where the external sensing system data comprises external RADAR data, the at least one sensor processor 234 may determine the state estimate based at least in part on the external RADAR data. For example, the at least one sensor processor 234 may execute an object recognition algorithm using the external RADAR data as an input to determine the state estimate.

In some embodiments, the external sensing system 199 is configured to determine a state estimate confidence metric. In particular, the at least one sensor processor 234 determines the state estimate confidence metric. The state estimate confidence metric is indicative of an error associated with the state estimate. The state estimate confidence metric may be referred to as a vehicle state estimate confidence metric.

The at least one sensor processor 234 determines the state estimate confidence metric based at least in part on the external sensing system data. The at least one sensor processor 234 determines the state estimate confidence metric based at least in part on one of the inputs used to determine the state estimate (e.g. the external sensing system data). For example, the at least one sensor processor 234 may determine the state estimate confidence metric based at least in part on an error associated with one or more of the external sensing system visible spectrum data, the external LIDAR data and external RADAR data.

In some embodiments, the at least one sensor processor 234 determines the state estimate and the state estimate confidence metric by using the external sensing system data (e.g. the external image data) as an input of a convolutional neural network.

The external sensing system sensor 228 is configured to determine the object state estimate. In particular, the at least one sensor processor 234 determines the object state estimate. The object state estimate is indicative of a state of the object 113, as previously described. The at least one sensor processor 234 determines the object state estimate based at least in part on the external sensing system data.

The at least one sensor processor 234 determines the object state estimate based at least in part on the external sensing system data. Where the external sensing system data comprises external sensing system visible spectrum data, the at least one sensor processor 234 may determine the object state estimate based at least in part on the external sensing system visible spectrum data. For example, the at least one sensor processor 234 may execute an object recognition algorithm using the external sensing system visible spectrum data as an input to determine the object state estimate.

Where the external sensing system data comprises external LIDAR data, the at least one sensor processor 234 may determine the object state estimate based at least in part on the external LIDAR data. For example, the at least one sensor processor 234 may execute an object recognition algorithm using the external LIDAR data as an input to determine the object state estimate.

Where the external sensing system data comprises external RADAR data, the at least one sensor processor 234 may determine the object state estimate based at least in part on the external RADAR data. For example, the at least one sensor processor 234 may execute an object recognition algorithm using the external RADAR data as an input to determine the object state estimate.

In some embodiments, the external sensing system 199 is configured to determine an object state estimate confidence metric. In particular, the at least one sensor processor 234 determines the object state estimate confidence metric. The object state estimate confidence metric is indicative of an error associated with the object state estimate.

The at least one sensor processor 234 determines the object state estimate confidence metric based at least in part on the external sensing system data. The at least one sensor processor 234 determines the object state estimate confidence metric based at least in part on one of the inputs used to determine the object state estimate (e.g. the external sensing system data). For example, the at least one sensor processor 234 may determine the object state estimate confidence metric based at least in part on an error associated with one or more of the external sensing system visible spectrum data, the external LIDAR data and external RADAR data. In other words, in some embodiments the at least one sensor processor 234 determines the object state estimate confidence metric based at least in part on the external sensing system data.

In some embodiments, the at least one sensor processor 234 determines the object state estimate and the object state estimate confidence metric by using the external sensing system data (e.g. the external image data) as an input of a convolutional neural network.

In some embodiments, the object state estimate comprises an object classification. The object classification is indicative of a class of the object 113. For example, the object 113 may be classified as a bird, an aerial vehicle etc.

In some embodiments, the external sensing system sensor 228 is configured to determine a partial state estimate. In particular, the at least one sensor processor 234 determines the partial state estimate. The partial state estimate comprises part of the parameters of the state estimate. For example, the partial state estimate may comprise the position estimate alone, the speed vector alone, the attitude vector alone or a combination of two of these. Alternatively, the partial state estimate may comprise part of the parameters that the position estimate, speed vector and/or attitude vector comprise. For example, where the speed vector indicates a velocity of the manned VTOL aerial vehicle 100 in three-dimensional space, the partial state estimate may comprise a partial speed vector that is indicative of a velocity of the manned VTOL aerial vehicle 100 in a one-dimension space, or in a two-dimensional space (i.e. a plane). The partial state estimate may therefore comprise one or more of a partial position estimate, a partial speed vector and a partial attitude vector.

As described herein, the state estimate comprises the position estimate, the speed vector and the attitude vector. In some cases, the external sensing system data available to the central server system 103 may be insufficient to enable the at least one sensor processor 234 to determine each of the position estimate, the speed vector and the attitude vector, and therefore the state estimate. In many cases however, determining even a sub-set of the parameters of the state estimate (i.e. the partial state estimate) can provide useful information.

For example, as previously described, where the external sensing system 199 comprises an external sensing system sensor 228 in the form of a visible spectrum camera, the visible spectrum image data provided by the visible spectrum camera may only be usable to provide information relating to the azimuth and elevation of an object within a field of view of the visible spectrum camera. In this case, if no, or insufficient, additional information is available to the at least one sensor processor 234 to enable determination of the state estimate, the at least one sensor processor 234 can determine the partial state estimate (which may also be referred to as an incomplete state estimate). If the visible spectrum camera is positioned such that it provides an appropriate view point, or if it is positioned at a known location relative to an obstacle or track infrastructure, the partial state estimate determined based on the provided visible spectrum image data can be sufficient to validate one or more safety parameters associated with the manned VTOL aerial vehicle 100 (e.g. determining whether an observed velocity in a particular direction will result in collision with the object or track infrastructure of known position). The at least one sensor processor 234 is configured to transmit the partial state estimate to the manned VTOL aerial vehicle 100.

In some embodiments, the external sensing system sensor 228 is configured to determine a partial object state estimate. In particular, the at least one sensor processor 234 determines the partial object state estimate. The partial object state estimate comprises part of the parameters that the object state estimate comprises. For example, the partial object state estimate may comprise the object position estimate alone, the object speed vector alone, the object attitude vector alone or a combination of two of these. Alternatively, the partial object state estimate may comprise part of the parameters that the object position estimate, object speed vector and/or object attitude vector comprise. For example, where the object speed vector indicates a velocity of the object 113 in three-dimensional space, the partial object state estimate may comprise a partial object speed vector that is indicative of a velocity of the object 113 in a one-dimension space, or in a two-dimensional space (i.e. a plane). The partial object state estimate may therefore comprise one or more of a partial object position estimate, a partial object speed vector and a partial object attitude vector.

As described herein, the object state estimate comprises the object position estimate, the object speed vector and the object attitude vector. In some cases, the external sensing system data available to the at least one sensor processor 234 may be insufficient to enable the at least one sensor processor 234 to determine each of the object position estimate, the object speed vector and the object attitude vector, and therefore the object state estimate. In many cases however, determining even a sub-set of the parameters of the object state estimate (i.e. the partial object state estimate) can provide useful information.

For example, as previously described, where the external sensing system 199 comprises an external sensing system sensor 228 in the form of a visible spectrum camera, the visible spectrum image data provided by the visible spectrum camera may only be usable to provide information relating to the azimuth and elevation of the object 113 when it is within a field of view of the visible spectrum camera. In this case, if no, or insufficient additional information is available to the at least one sensor processor 234 to enable determination of the object state estimate, the at least one sensor processor 234 can determine the partial object state estimate (which may also be referred to as an incomplete object state estimate) which is still useful. If the visible spectrum camera is positioned such that it provides an appropriate view point, or if it is positioned at a known location relative to the object 113 or track infrastructure, the partial object state estimate determined based on the provided visible spectrum image data can be sufficient to validate one or more safety parameters associated with the object 113 (e.g. determining whether an observed velocity in a particular direction will result in the object 113 colliding with track infrastructure of known position or the manned VTOL aerial vehicle 100). The at least one sensor processor 234 is configured to transmit the partial object state estimate to the manned VTOL aerial vehicle 100.

As previously described, the external sensing system 199 is configured to store a three-dimensional model. In particular, the sensor memory 236 is configured to store the three-dimensional model. The three-dimensional model represents the region. The three-dimensional model may be pre-defined.

The at least one sensor processor 234 is configured to modify the three-dimensional model, based at least in part on the object state estimate. The at least one sensor processor 234 is configured to modify the three-dimensional model based at least in part on the object state estimate confidence metric. The at least one sensor processor 234 is therefore configured to determine a modified three-dimensional model, based at least in part on the object state estimate and/or the object state estimate confidence metric.

The at least one sensor processor 234 is configured to modify the three-dimensional model, based at least in part on the state estimate. The at least one sensor processor 234 is configured to modify the three-dimensional model based at least in part on the state estimate confidence metric. The at least one sensor processor 234 is therefore configured to determine a modified three-dimensional model, based at least in part on the state estimate and/or the state estimate confidence metric.

For example, when the manned VTOL aerial vehicle 100 participates in a race where there is a crash, or a desired change to the track 230 mid-race, the at least one sensor processor 234 may detect the crash (by the previously described object detection) and modify the three-dimensional model representing the region such that section of the track 230 is a no-fly zone or includes a course alteration.

In some embodiments, the at least one central sensor processor 234 is configured to determine an alert. The at least one sensor processor 234 determines the alert based at least in part on the state estimate. The at least one sensor processor 234 determines the alert based at least in part on the state estimate confidence metric. The at least one sensor processor 234 determines the alert based at least in part on the object state estimate. The at least one sensor processor 234 determines the alert based at least in part on the object state estimate confidence metric. For example, when the manned VTOL aerial vehicle 100 participates in a race where there is a crash, or a desired change to the track 230 mid-race, the at least one sensor processor 234 may detect the crash (by the previously described object detection) and generate an alert to indicate that section of the track 230 is a no-fly zone or includes a course alteration.

The external sensing system 199 is configured to transmit wireless information. In particular, the at least one sensor processor 234 is configured to transmit the wireless information to the manned VTOL aerial vehicle 100. In cases where there is a plurality of external sensing system sensors 228, each external sensing system sensor 228 is configured to transmit the wireless information. The external sensing system sensors 228 may transmit the wireless information to the manned VTOL aerial vehicle 100, or to another external sensing system sensor 228, which may subsequently transmit the wireless information to the manned VTOL aerial vehicle 100 (i.e. acting as a repeater).

The wireless information comprises the object state estimate. The wireless information comprises the object state estimate confidence metric. The wireless information comprises the state estimate. The wireless information comprises the state estimate confidence metric. The wireless information comprises the three-dimensional model. The wireless information comprises the modified three-dimensional model. The wireless information comprises the alert. The manned VTOL aerial vehicle 100 is configured to receive the wireless information using the communication system 122.

In some embodiments, the wireless information comprises the state estimate. The wireless information may also comprise the state estimate confidence metric. The wireless information comprises classification data. The classification data comprises the object classification. In some embodiments, the one or more external sensing system sensors 228 is configured to classify the object 113 based at least in part on the external sensing system data. Thus, the central server system 103 may determine the object classification.

The wireless information comprises identification information. The identification information comprises an identifier that is associated with the manned VTOL aerial vehicle 100. For example, the identification information may comprise a unique identification number that is associated with the manned VTOL aerial vehicle 100. In some embodiments, the one or more external sensing system sensors 228 is configured to determine the identification information based at least in part on the external sensing system data. The one or more external sensing system sensors 228 may determine one or more characteristics associated with the manned VTOL aerial vehicle 100 based at least in part on the external sensing system data. The characteristics may comprise one or more of an estimated length, an estimated width or an estimated depth of the manned VTOL aerial vehicle 100, for example.

In some embodiments, the manned VTOL aerial vehicle 100 is configured to transmit vehicle data using the communication system 122. In particular, the manned VTOL aerial vehicle 100 is configured to wirelessly transmit vehicle data using the communication system 122. Each external sensing system sensor 228 is configured to receive the vehicle data. In particular, the at least one sensor processor 228 of each external sensing system sensor 228 is configured to receive the vehicle data. For example, the at least one sensor processor 228 may receive the vehicle data using a sensor wireless communication module (not shown).

The at least one processor 132 of the manned VTOL aerial vehicle 100 may control the propulsion system 106 of the manned VTOL aerial vehicle 100 to avoid the object 113 (or the plurality of objects 113, where relevant). In particular, the at least one processor 132 may control the propulsion system 106 of the manned VTOL aerial vehicle 100 to avoid the object 113 based at least in part on the state estimate received from the external sensing system 199. The at least one processor 132 may control the propulsion system 106 of the manned VTOL aerial vehicle 100 to avoid the object 113 based at least in part on the state estimate received from the relevant external sensing system sensor 228. The at least one processor 132 may control the propulsion system 106 of the manned VTOL aerial vehicle 100 to avoid the object 113 whilst remaining within the region.

The at least one processor 132 may control the propulsion system 106 of the manned VTOL aerial vehicle 100 to avoid the object 113 based at least in part on the state estimate confidence metric received from the external sensing system 199.

The at least one processor 132 may control the propulsion system 106 of the manned VTOL aerial vehicle 100 to avoid the object 113 based at least in part on the object state estimate received from the external sensing system 199. The at least one processor 132 may control the propulsion system 106 of the manned VTOL aerial vehicle 100 to avoid the object 113 based at least in part on the object state estimate confidence metric received from the external sensing system 199.

In some embodiments, the at least one processor 132 controls the propulsion system 106 of the manned VTOL aerial vehicle 100 to avoid the object 113 based at least in part on the three-dimensional model or the modified three-dimensional model.

The at least one processor 132 controls the propeller drive systems 114 to rotate the propellers as necessary to control the manned VTOL aerial vehicle 100 in accordance with a control vector. The at least one processor 132 determines the control vector used to control the propulsion system 106 based at least in part on one or more of the state estimate, the state estimate confidence metric, the object state estimate and the object state estimate confidence metric. In some embodiments, the at least one processor 132 determines the control vector based at least in part on the three-dimensional model or the modified three-dimensional model.

In some embodiments, the at least one processor 132 controls the propulsion system 106 of the manned VTOL aerial vehicle 100 such that the manned VTOL aerial vehicle 100 avoids colliding with the object, based at least in part on the state estimate and the object state estimate.

The at least one processor 132 may provide an alert to the pilot. The alert may be in the form of a warning. The at least one processor 132 may determine the alert based at least in part on the sensor data. The at least one processor 132 may display the alert using the display of the cockpit 104. In some embodiments, the display is in the form of a heads-up display. In these embodiments, the at least one processor 132 may display the alert using the heads-up display. In some embodiments, the alert may comprise an audio output. In some embodiments, the alert may comprise haptic feedback, for example, through a seat of the cockpit 104 or the pilot-operable controls 118. The at least one processor may execute the cockpit warning system 161 to determine and/or display the alert.

As previously described, in some embodiments, the manned VTOL aerial vehicle 100 is configured to transmit vehicle data using the communication system 122. One or more of the external sensing system sensors 228 is also configured to transmit wireless information as previously described.

In some embodiments, the vehicle data comprises one or more of the state estimate and the state estimate confidence metric. The vehicle data comprises one or more of the object state estimate and the object state estimate confidence metric. The vehicle data comprises classification data. The classification data comprises the object classification. The vehicle data comprises identification information. The identification information comprises an identifier that is associated with the manned VTOL aerial vehicle 100. For example, the identification information may comprise a unique identification number that is associated with the manned VTOL aerial vehicle 100.

In some embodiments, the communications network 105 is configured to support the localisation of the manned VTOL aerial vehicle 100. A localisation of the manned VTOL aerial vehicle 100 may comprise the state estimate, or a part thereof (e.g. the position estimate, speed vector and/or attitude vector). The three-dimensional model described herein may include infrastructure of the communications network 105 or infrastructure such as the repeaters 107. One or more components of the communications network 105 or the central server system communication system 226 may be associated with pre-defined position(s) within the three-dimensional model as previously described.

As previously described, the manned VTOL aerial vehicle 100 is configured to communicate using the communications network 105. The central server system 103 is configured to use data provided by the communications network 105 or the external sensing system 199 when determining position, velocity, attitude, angular rate and/or other estimates associated with the manned VTOL aerial vehicle 100. The data associated with the manned VTOL aerial vehicle 100 may be referred to as localisation data, and may comprise one or more of the data types described herein (e.g. GNSS data, accelerometer data etc.).

In some embodiments, the manned VTOL aerial vehicle 100 is configured to use the localisation data provided by the communications network 105 or the external sensing system 199 when determining the state estimate and/or state estimate confidence metric. As the communications network 105 includes communications infrastructure to enable communication with the manned VTOL aerial vehicle 100, and the external sensing system 199 includes infrastructure and pre-defined positions, where the manned VTOL aerial vehicle 100 is able to communicate with one or more components of the communications network 105 or the external sensing system 199, the manned VTOL aerial vehicle can use Round Trip Time (RTT) determination, or techniques such as Time Differential of Arrival (TDOA) to determine and/or improve the state estimate and/or state estimate confidence metric. In some embodiments, this additional localisation data can complement the GNSS data to improve the state estimate and/or state estimate confidence metric. The sensor data may comprise the localisation data, the RTT determination, TDOA data or other localisation data. The external sensing system data may comprise the localisation data, the RTT determination, TDOA data or other localisation data.

### Alternative Control System 116 Architecture

Although the manned VTOL aerial vehicle 100 has been described with reference to the control system 116 of FIG. 5, it will be understood that the manned VTOL aerial vehicle 100 may comprise alternative control system 116 architecture. FIG. 6 illustrates an alternative control system 116, according to some embodiments.

FIG. 6 is a block diagram of the control system 116, according to some embodiments. The control system 116 illustrated in FIG. 6 comprises a first control system 142 and a second control system 144. The first control system 142 comprises at least one first control system processor 146. The at least one first control system processor 146 is configured to be in communication with first control system memory 148. The sensing system 120 may be as previously described. The sensing system 120 is configured to communicate with the at least one first control system processor 146. In some embodiments, the sensing system 120 is configured to provide the sensor data to the at least one first control system processor 146. In some embodiments, the at least one first control system processor 146 is configured to receive the sensor data from the sensing system 120. In some embodiments, the at least one first control system processor 146 is configured to retrieve the sensor data from the sensing system 120. The at least one first control system processor 146 is configured to store the sensor data in the first control system memory 148.

The at least one first control system processor 146 is configured to execute first control system program instructions stored in first control system memory 148 to cause the first control system 142 to function as described herein. In particular, the at least one first control system processor 146 is configured to execute the first control system program instructions to cause the manned VTOL aerial vehicle 100 to function as described herein. In other words, the first control system program instructions are accessible by the at least one first control system processor 146, and are configured to cause the at least one first control system processor 146 to function as described herein.

In some embodiments, the first control system program instructions are in the form of program code. The at least one first control system processor 146 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The first control system program instructions comprise the depth estimating module 135, the three-dimensional map module 136, the visual odometry module 137, the particle filter module 138, the region mapping module 159 and the collision avoidance module 140.

First control system memory 148 may comprise one or more volatile or non-volatile memory types. For example, first control system memory 148 may comprise one or more of random access memory (RAM), read-only memory (ROM), electrically erasable programmable read-only memory (EEPROM) or flash memory. First control system memory 148 is configured to store program code accessible by the at least one first control system processor 146. The program code may comprise executable program code modules. In other words, first control system memory 148 is configured to store executable code modules configured to be executable by the at least one first control system processor 146. The executable code modules, when executed by the at least one first control system processor 146 cause the at least one first control system processor 146 to perform certain functionality, as described herein. In the illustrated embodiment, the depth estimating module 135, the three-dimensional map module 136, the visual odometry module 137, the particle filter module 138, the collision avoidance module 140, and the DNN detection and tracking module 143 are in the form of program code stored in the first control system memory 138.

The second control system 144 comprises at least one second control system processor 150. The at least one second control system processor 150 is configured to be in communication with second control system memory 152. The sensing system 120 is configured to communicate with the at least one second control system processor 150. The sensing system 120 may be as previously described. The at least one second control system processor 150 is configured to execute second control system program instructions stored in second control system memory 152 to cause the second control system 144 to function as described herein. In particular, the at least one second control system processor 150 is configured to execute the second control system program instructions to cause the manned VTOL aerial vehicle 100 to function as described herein. In other words, the second control system program instructions are accessible by the at least one second control system processor 150, and are configured to cause the at least one second control system processor 150 to function as described herein.

In some embodiments, the second control system 144 comprises some or all of the sensing system 120. The control system 120 may be as previously described. The sensing system 120 is configured to communicate with the at least one second control system processor 150. In some embodiments, the sensing system 120 is configured to provide the sensor data to the at least one second control system processor 150. In some embodiments, the at least one second control system processor 150 is configured to receive the sensor data from the sensing system 120. In some embodiments, the at least one second control system processor 150 is configured to retrieve the sensor data from the sensing system 120. The at least one second control system processor 150 is configured to store the sensor data in the second control system memory 152.

In some embodiments, the second control system program instructions are in the form of program code. The at least one second control system processor 150 comprises one or more microprocessors, central processing units (CPUs), application specific instruction set processors (ASIPs), application specific integrated circuits (ASICs), graphics processing units (GPUs), tensor processing units (TPUs), field-programmable gate arrays (FPGAs) or other processors capable of reading and executing program code. The second control system program instructions comprise the state estimating module 139, the cockpit warning module 161 and the control module 141.

Second control system memory 152 may comprise one or more volatile or non-volatile memory types. For example, second control system memory 152 may comprise one or more of random access memory (RAM), read-only memory (ROM), electrically erasable programmable read-only memory (EEPROM) or flash memory. Second control system memory 152 is configured to store program code accessible by the at least one second control system processor 150. The program code may comprise executable program code modules. In other words, second control system memory 152 is configured to store executable code modules configured to be executable by the at least one second control system processor 150. The executable code modules, when executed by the at least second control system processor 150 cause the at least one second control system processor 150 to perform certain functionality, as described herein. In the illustrated embodiment, the control module 140 is in the form of program code stored in the second control system memory 152.

The first control system 142 is configured to communicate with the second control system 144. The first control system 142 may comprise a first control system network interface (not shown). The first control system network interface is configured to enable the first control system 142 to communicate with the second control system 144 over one or more communication networks. In particular, the first control system processor 146 may be configured to communicate with the second control system processor 150 using the first control system network interface. The first control system 142 may comprise a combination of network interface hardware and network interface software suitable for establishing, maintaining and facilitating communication over a relevant communication channel. Examples of a suitable communications network include a communication bus, cloud server network, wired or wireless network connection, cellular network connection, Bluetooth™ or other near field radio communication, and/or physical media such as a Universal Serial Bus (USB) connection.

The second control system 144 may comprise a second control system network interface (not shown). The second control system network interface is configured to enable the second control system 144 to communicate with the first control system 142 over one or more communication networks. In particular, the second control system processor 150 may be configured to communicate with the first control system processor 146 using the second control system network interface. The second control system 144 may comprise a combination of network interface hardware and network interface software suitable for establishing, maintaining and facilitating communication over a relevant communication channel. Examples of a suitable communications network include a communication bus, cloud server network, wired or wireless network connection, cellular network connection, Bluetooth™ or other near field radio communication, and/or physical media such as a Universal Serial Bus (USB) connection.

The first control system 142 may be considered a high-level control system. That is, the first control system 142 may be configured to perform computationally expensive tasks. The second control system 144 may be considered a low-level control system. The second control system 144 may be configured to perform computationally less-expensive tasks than the first control system 144.

### Alternative Piloting System

In some embodiments, the manned VTOL aerial vehicle 100 may be piloted remotely. That is, the manned VTOL aerial vehicle 100 may comprise a remote cockpit 104. In other words, the cockpit 104 may be in the form of a remote cockpit 104. The remote cockpit 104 may be in a different location to that of the manned VTOL aerial vehicle 100. For example, the remote cockpit 104 may be in a room that is separated from the manned VTOL aerial vehicle 100 (e.g. a cockpit replica ground station).

The remote cockpit 104 can be similar or identical to the cockpit 104. That is, the remote cockpit 104 may comprise the pilot-operable controls 118. The remote cockpit 104 comprises at least one display. The display is configured to display at least some of the vehicle data transmitted by the manned VTOL aerial vehicle 100. For example, the display is configured to display one or more of the visible spectrum image data, vehicle state estimate, vehicle state estimate confidence metric, object state estimate, object state estimate confidence metric, GNSS data, altitude data, accelerometer data, gyroscopic data, magnetic field data, LIDAR data and RADAR data, or a portion thereof.

The remote cockpit 104 may comprise a remote cockpit communication system. The remote cockpit communication system is configured to enable the remote cockpit 104 to communicate with the manned VTOL aerial vehicle 100. For example, the remote cockpit 104 may communicate with the manned VTOL aerial vehicle 100 via a radio frequency link. In some embodiments, the remote cockpit 104 may communicate with the manned VTOL aerial vehicle 100 using the communications network 105. The remote cockpit 104 may provide the input vector to the manned VTOL aerial vehicle 100. In particular, the at least one processor 132 (or the control system 116) may receive the input vector from the remote cockpit 104.

The manned VTOL aerial vehicle 100 is configured to communicate with the remote cockpit 104 using the communication system 122. The manned VTOL aerial vehicle 100 may be configured to communicate with the remote cockpit 104 via the radio frequency link and/or the communications network 105. The manned VTOL aerial vehicle 100 is configured to provide vehicle data to the remote cockpit 104. For example, the manned VTOL aerial vehicle 100 is configured to provide a video feed and/or telemetry data to the remote cockpit 104. The remote cockpit 104 may comprise a cockpit display configured to display the video feed and/or telemetry data for the pilot.

### Operation of the Manned VTOL Aerial Vehicle 100 Via the Central Server System 103

In some embodiments, the manned VTOL aerial vehicle 100 comprises the pilot operable controls 118 and the central server system 103 comprises the remote cockpit 104. Both the pilot-operable controls 118 and the remote cockpit 104 may be used to control the manned VTOL aerial vehicle 100. For example, the remote cockpit 104 may be configured to receive inputs from a supervising operator. The manned VTOL aerial vehicle 100 may be configured to operate in accordance with the inputs from the supervising operator received via the remote cockpit 104.

In some embodiments, the central server system 103 comprises a user interface (not shown). The user interface comprises a display that is configured to display information, such as a graphical user interface, to the supervising operator. The display may comprise one or more LCD, LED, OLED, plasma, cathode-ray or other displays. The display may be or include a touch-screen display. The user interface comprises an input device. The input device may comprise one or more buttons, switches, keyboards, digital mice, joysticks, microphones, touch-screens or other input devices. The input device is configured to communicate one or more inputs provided by the supervising operator to the central server system 103. The manned VTOL aerial vehicle 100 may be configured to operate in accordance with the inputs from the supervising operator received via the user interface.

The remote cockpit 104 and/or the user interface may be used by the supervising operator to generate and/or provide warnings or messages to the manned VTOL aerial vehicle 100 and/or the pilot of the manned VTOL aerial vehicle 100. Similarly, the remote cockpit 104 and/or the user interface may be used by the supervising operator to create, modify or remove virtual boundaries of the region, parameters associated with virtual objects and/or no-fly zones. The remote cockpit 104 and/or the user interface may be used by the supervising operator to send high level commands to the manned VTOL aerial vehicle 100 to, for example, change a flight mode of the manned VTOL aerial vehicle, change performance of the manned VTOL aerial vehicle 100 (e.g. to introduce a maximum velocity threshold) or change another parameter associated with the manned VTOL aerial vehicle 100.

In some embodiments, the central server system 103 comprises a plurality of remote cockpits 104 and/or user interfaces. In some embodiments, the central server system 103 comprises a plurality of displays. Each of the plurality of displays is configured to display information associated with the manned VTOL aerial vehicle 100 and/or the central server system 103 (e.g. the vehicle data, wireless information etc.).

In some embodiments, the inputs received via the pilot-operable controls 118 are associated with a first priority. The first priority may be a number (e.g. between 0 and 1). The first priority is indicative of a priority of the inputs received via the pilot-operable controls 118. The inputs received via the remote cockpit 104 are associated with a second priority. The second priority may be a number (e.g. between 0 and 1). The second priority is indicative of a priority of the inputs received via the remote cockpit 104. The manned VTOL aerial vehicle 100 may priorities the inputs received via the pilot-operable controls 118 and the inputs received via the remote cockpit 104 based on the first priority and/or the second priority. For example, where the first priority is greater than the second priority, the manned VTOL aerial vehicle 100 may prioritise the inputs received via the pilot-operable controls 118. Similarly, where the second priority is greater than the first priority, the manned VTOL aerial vehicle 100 may prioritise inputs received via the remote cockpit 104. In some embodiments, the first priority may be associated with a first weighting that is applied to the inputs received via the pilot-operable controls 118. In some embodiments, the second priority may be associated with a second weighting that is applied to the inputs received via the remote cockpit 104.

### Unmanned VTOL Aerial Vehicle

In some embodiments, the manned VTOL aerial vehicle 100 may instead be an unmanned VTOL aerial vehicle. In such a case, the unmanned VTOL aerial vehicle may not include the cockpit 104. Furthermore, the pilot-operable control system 118 may be remote to the unmanned VTOL aerial vehicle. Alternatively, the unmanned VTOL aerial vehicle may be an autonomous unmanned VTOL aerial vehicle.

In some embodiments, the manned VTOL aerial vehicle 100 may be autonomously controlled. For example, the manned VTOL aerial vehicle 100 may be autonomously controlled during take-off and landing. The control system 116 may autonomously control the manned VTOL aerial vehicle 100 during these phases. In other words, the manned VTOL aerial vehicle 100 may be configured to be autonomously or manually switched between a fully autonomous control mode, in which pilot input to the pilot-operable controls is ignored for flight control purposes, and a shared control mode, in which the pilot can assume manual flight control of the vehicle 100 within an overall autonomous collision-avoidance control program.

### Use of Visible Landmarks

In some embodiments, the manned VTOL aerial vehicle 100 is configured to use visible landmarks to assist with localisation or other functionality. Localisation may include position, velocity, attitude and/or angular rate estimation, or estimation of other characteristics of the manned VTOL aerial vehicle 100. For example, a fixed landmark (i.e. a landmark that does not move) may be associated with a landmark position. The landmark position is indicative of a position of the landmark within a landmark coordinate system. The landmark coordinate system may correspond with the global coordinate system as previously described. Alternatively, the landmark coordinate system may correspond with a local coordinate system of the region described herein. In some embodiments, dynamic landmarks may also be used. Dynamic landmarks are landmarks for which a property is dynamic. For example, the position of a dynamic landmark may change with time.

Where the landmark is detected by one or more of the sensors of the sensing system 120, the manned VTOL aerial vehicle 100 is configured to determine the state estimate based at least in part on the detected landmark. Examples of landmarks include lines, lights, smoke or natural features such as trees. Other functionality, such as autonomous or semi-autonomous functionality may also be optimised based on the detected landmark. For example, the landmark may be indicative of a position of an emergency landing area, a nominal take off and/or landing area or a pit area.

It will be understood that for the purposes of this disclosure, that “manned” when referred to in the context of the manned VTOL aerial vehicle 100 is a configuration of the vehicle, rather than a state of the vehicle. That is, a pilot is not required at all times for the manned VTOL aerial vehicle 100 to be considered to be manned. The manned VTOL aerial vehicle 100 may be considered to be manned, at least because it comprises the pilot-operable controls 118 that are configured to be operated by the pilot when the pilot is seated in the cockpit 104. While the manned VTOL aerial vehicle 100 may be operated remotely, for example, via the remote cockpit 104, it is still appropriate to consider the manned VTOL aerial vehicle 100 as manned, as it comprises the pilot-operable controls 118.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A system comprising:
a central server system comprising:
a central server system wireless communication system;
at least one central server system processor; and
central server system memory; and
a manned VTOL aerial vehicle comprising:
a body comprising a cockpit;
a propulsion system carried by the body to propel the body during flight;
a communication system; and
a control system;
wherein:
the central server system memory stores program instructions accessible by the at least one central server system processor, and configured to cause the at least one central server system processor to wirelessly transmit wireless information using the central server system wireless communication system;
the manned VTOL aerial vehicle is configured to receive the wireless information using the communication system;
the wireless information comprises an object state estimate and an object state estimate confidence metric, wherein;
the object state estimate is indicative of a state of an object that is within a region; and
the object state estimate confidence metric is indicative of an error associated with the object state estimate; and
the control system is configured to control the propulsion system such that the manned VTOL aerial vehicle avoids the object while remaining within the region, based at least in part on the object state estimate and the object state estimate confidence metric.

2. The system of claim 1, wherein the control system is configured to enable control of the manned VTOL aerial vehicle to be shared between a pilot and an autonomous piloting system.

3. The system of claim 1, wherein:
the manned VTOL aerial vehicle is configured to transmit vehicle data using the communication system, and
the at least one central server system processor is configured to receive the vehicle data using the central server system wireless communication system.

4. The system of claim 1, wherein the object state estimate comprises one or more of:
an object position estimate that is indicative of a position of the object within the region;
an object speed vector that is indicative of a velocity of the object; and
an object attitude vector that is indicative of an attitude of the object.

5. The system of claim 1, wherein:
the wireless information comprises a vehicle state estimate and a vehicle state estimate confidence metric;
the vehicle state estimate is indicative of a state of the manned VTOL aerial vehicle within the region;
the vehicle state estimate confidence metric is indicative of an error associated with the vehicle state estimate; and
wherein the vehicle state estimate comprises one or more of:
a position estimate indicative of a position of the manned VTOL aerial vehicle within the region;
a speed vector indicative of a velocity of the manned VTOL aerial vehicle; and
an attitude vector that is indicative of an attitude of the manned VTOL aerial vehicle.

6. (canceled)

7. The system of claim 5, wherein the control system is configured to control the propulsion system such that the manned VTOL aerial vehicle avoids the object while remaining within the region, based at least in part on the object state estimate, the object state estimate confidence metric, the vehicle state estimate and the vehicle state estimate confidence metric.

8. The system of claim 1, further comprising an external sensing system configured to generate external sensing system data, wherein the external sensing system is configured to provide the external sensing system data to the central server system; and
wherein the external sensing system comprises an external sensing system imaging system that is configured to generate external sensing system image data, wherein the external sensing system data comprises the external sensing system image data.

9. (canceled)

10. The system of claim 8, wherein the external sensing system imaging system comprises one or more of:
an external LIDAR module configured to generate external LIDAR data associated with the region;
an external visible spectrum camera configured to generate external sensing system visible spectrum data associated with the region; and
an external RADAR module configured to generate external RADAR data associated with the region; and
wherein the external sensing system image data comprises one or more of the external LIDAR data, the external sensing system visible spectrum data and the external RADAR data.

11. The system of claim 1, further comprising a repeater;
wherein the repeater is configured to receive the wireless information transmitted by the central server system and re-transmit the wireless information, thereby enabling the central server system to provide the wireless information to the manned VTOL aerial vehicle from an extended distance; and
wherein the repeater is configured to receive vehicle data transmitted by the manned VTOL aerial vehicle, and re-transmit the vehicle data, thereby enabling the manned VTOL aerial vehicle to provide the vehicle data to the central server system from an extended distance.

12-13. (canceled)

14. The system of claim 8, wherein the program instructions are further configured to cause the at least one central server system processor to determine the object state estimate and the object state estimate confidence metric based at least in part on the external sensing system data.

15. The system of claim 1, wherein the program instructions are further configured to cause the at least one central server system processor to determine the vehicle state estimate based at least in part on the external sensing system data.

16. The system of claim 89, wherein the program instructions are further configured to cause the at least one central server system processor to determine the object state estimate and the object state estimate confidence metric by using the external image data as an input of a convolutional neural network.

17. The system of claim 8, wherein:
the wireless information comprises a vehicle state estimate and a vehicle state estimate confidence metric;
the vehicle state estimate is indicative of a state of the manned VTOL aerial vehicle within the region;
the vehicle state estimate confidence metric is indicative of an error associated with the vehicle state estimate; and
wherein the program instructions are further configured to cause the at least one central server system processor to determine the vehicle state estimate and the vehicle state estimate confidence metric by using the image data as an input of a convolutional neural network.

18. The system of claim 8, wherein the external sensing system comprises a sensor comprising:
a sensor module configured to generate sensor data;
at least one sensor processor; and
sensor memory storing sensor program instructions accessible by the at least one sensor processor, and configured to cause the at least one sensor processor to determine the object state estimate and the object state estimate confidence metric, based at least in part on the external sensing system data; and
wherein the sensor program instructions are further configured to cause the at least one sensor processor to provide the object state estimate and the object state estimate confidence metric to the central server system.

19. (canceled)

20. The system of claim 8, wherein:
the wireless information comprises a vehicle state estimate and a vehicle state estimate confidence metric;
the vehicle state estimate is indicative of a state of the manned VTOL aerial vehicle within the region;
the vehicle state estimate confidence metric is indicative of an error associated with the vehicle state estimate; and
wherein the external sensing system comprises a sensor comprising:
a sensor module configured to generate sensor data;
at least one sensor processor; and
sensor memory storing sensor program instructions accessible by the at least one sensor processor, and configured to cause the at least one sensor processor to determine the vehicle state estimate and the vehicle state estimate confidence metric, based at least in part on the external sensing system data; and
wherein the sensor program instructions are further configured to cause the at least one sensor processor to provide the vehicle state estimate and the vehicle state estimate confidence metric to the central server system.

21. (canceled)

22. The system of claim 1, wherein the object state estimate comprises an object classification that is indicative of a class of the object.

23. The system of claim 1, wherein:
the central server system memory is configured to store a three-dimensional model that represents the region;
wherein the program instructions are further configured to cause the at least one central server system processor to modify the three-dimensional model, based at least in part on the object state estimate and the object state estimate confidence metric, thereby determining a modified three-dimensional model; and
the wireless information comprises the modified three-dimensional model.

24. (canceled)

25. The system of claim 18, wherein:
the sensor memory is configured to store a pre-defined three-dimensional model that represents the region;
the sensor program instructions are further configured to cause the at least one sensor processor to modify the pre-defined three-dimensional model, based at least in part on the object state estimate and the object state estimate confidence metric, thereby determining a modified three-dimensional model; and
the wireless information comprises the modified three-dimensional model.

26-27. (canceled)

28. A system comprising:
a sensor configured to generate sensor data, the sensor comprising:
a sensor module configured to generate the sensor data;
a sensor wireless communication module;
at least one sensor processor; and
sensor memory that is configured to store the sensor data; and
a manned VTOL aerial vehicle comprising:
a body comprising a cockpit;
a propulsion system carried by the body to propel the body during flight;
a vehicle wireless communication system; and
a control system;
wherein:
the sensor memory stores sensor program instructions accessible by the at least one sensor processor, and configured to cause the at least one sensor processor to:
determine an object state estimate and an object state estimate confidence metric, based at least in part on the sensor data, wherein:
the object state estimate is indicative of a state of an object that is within a region; and
the object state estimate confidence metric is indicative of an error associated with the object state estimate; and
wirelessly transmit wireless information using the sensor wireless communication module, the wireless information comprising the object state estimate and the object state estimate confidence metric;
the manned VTOL aerial vehicle is configured to receive the wireless information using the vehicle wireless communication system; and
the control system is configured to control the propulsion system such that the manned VTOL aerial vehicle avoids the object while remaining within the region, based at least in part on the object state estimate and the object state estimate confidence metric.

29-48. (canceled)

49. A system comprising:
a central server system comprising:
a central server system wireless communication system;
at least one central server system processor; and
central server system memory; and
a manned VTOL aerial vehicle comprising:
a body comprising a cockpit;
a propulsion system carried by the body to propel the body during flight;
a communication system; and
a control system;
wherein:
the central server system memory stores program instructions accessible by the at least one central server system processor, and configured to cause the at least one central server system processor to wirelessly transmit wireless information using the central server system wireless communication system;
the manned VTOL aerial vehicle is configured to receive the wireless information using the communication system; and
the control system is configured to control the propulsion system based at least in part on the wireless information.

50. A system for communicating with vertical take-off and landing (VTOL) aerial vehicles, the system comprising:
a central server system comprising:
a central server system wireless communication system;
at least one central server system processor; and
central server system memory;
wherein:
the central server system memory stores program instructions accessible by the at least one central server system processor, and configured to cause the at least one central server system processor to wirelessly transmit wireless information to one or more VTOL aerial vehicles using the central server system wireless communication system;
the wireless information comprises an object state estimate and an object state estimate confidence metric, wherein;
the object state estimate is indicative of a state of an object that is within a region; and
the object state estimate confidence metric is indicative of an error associated with the object state estimate.

51-94. (canceled)
